(19) United States
(12) Patent Application Publication
(10) Pub. No.: US 2009/0251849 A1
(43) Pub. Date: Oct. 8, 2009

(54) Energy Storage Device Having Novel Energy Storage Means

(76) Inventors: Hideo Yamagishi, Kyoto (JP); Masamitsu Tachibana, Osaka (JP); Mutsuaki Murakami, Osaka (JP); Yasuhiro Tsukada, Hyogo (JP); Hiroyuki Furutani, Osaka (JP)

Correspondence Address: BIRCH STEWART KOLASCH & BIRCH, PO BOX 747, FALLS CHURCH, VA, 22040-0747, US

(21) Appl. No.: 12/084,154

(22) PCT Filed: Nov. 2, 2006
(86) PCT No.: PCT/JP2006/322005

§ 371 Date: Apr. 25, 2008

(30) Foreign Application Priority Data
Oct. 10, 2005 (JP) 2006 276776
Nov. 2, 2005 (JP) 2005 319788
Jun. 28, 2006 (JP) 2006 178436
Jul. 7, 2006 (JP) 2006 188436

(51) Int. Cl. H01G 9/038; H01G 9/035

(52) U.S. Cl. 361/502; 361/504; 29/25.03

(57) ABSTRACT

Disclosed is an energy storage device having high energy density and excellent power density. For example, electric double layer capacitors, redox capacitors, lithium ion electrolyte type capacitors and devices applying any of them are greatly improved in the energy density without deteriorating their advantages such as high power density, high charge/discharge efficiency and long life. Specifically disclosed is an energy storage device containing a positive electrode, a negative electrode and an electrolyte solution, which device is characterized in that a compound capable of performing a doping/dedoping reaction is present in the electrolyte solution.

### TECHNICAL FIELD

The present invention relates to an energy storage device having a novel energy storage means. The present invention relates to an energy storage device comprising a mechanism storing energy by a doping/dedoping reaction of a compound capable of performing a doping/dedoping reaction contained in an electrolytic solution, and is applicable to an electric double layer capacitor, a redox capacitor, a lithium ion electrolytic capacitor or an applied device thereof.

### BACKGROUND ART

An electric double layer capacitor or the like has recently been noted as an energy storage device. The electric double layer capacitor is an electrochemical device for power storage utilizing electric double layer capacitance formed on the interface between an electrode and an electrolyte upon application of a voltage. The mechanism of power storage with this electric double layer capacitance is capable of quicker charge/discharge as compared with a secondary cell attending an electrochemical reaction, and also has an excellent repetitive life characteristic. The electric double layer capacitor is expected for application to a hybrid electric vehicle (HEV) or a fuel cell electric vehicle (FCEV) through these characteristics. However, the electric double layer capacitor disadvantageously has small energy density. The electric double layer capacitance is proportional to the surface area of the electrode, and hence activated charcoal having a large surface area is generally employed as the electrode. However, the energy density is low at present, and hence increase of the capacitance is demanded.

In consideration of such circumstances, a capacitor employing pseudo-capacitance by a conductive polymer is proposed in order to remarkably improve the capacitance density as compared with the electric double layer capacitor. The pseudo-capacitance is stored with an electron transfer process (Faraday process) on an electrode interface, dissimilarly to the electric double layer capacitance. Such pseudo-capacitance is developed by a redox reaction, i.e., a doping/dedoping reaction of a conductive polymer when the conductive polymer is employed. In particular, a π-conjugate polymer such as polypyrrole, polyaniline or polythiophene has high theoretical capacitance density, and is remarkably expected as an electrode (refer to Patent Documents 1 and 2, for example).

As an attempt to obtain a certain extent of energy density by combining the high energy density of a lithium ion secondary cell with such a capacitor expectable for high power density, the so-called lithium ion electrolytic capacitor storing power in one of electrodes of this capacitor through intercalation of lithium ions of graphite or the like is proposed (refer to Patent Document 3, for example).

Each of these capacitors utilizes the electrode or an electric double layer around the electrode as the energy storage means. In other words, electric energy is generally stored/released through transfer of the energy on a site concerned with the electrode such as oxidation/reduction of the electrode material, transfer of charges in the electric double layer around the electrode or adsorption/desorption of ions on the surface of the electrode. Consequently, the obtained energy density is limited.
Patent Document 1: Japanese Patent Laying-Open No. 6-104141
Patent Document 2: Japanese Patent Laying-Open No.2002-203742
Patent Document 3: Japanese Patent Laying-Open No. 8-107048

### DISCLOSURE OF THE INVENTION

### Problems to be Solved by the Invention

An object of the present invention is to provide an energy storage device having high energy density and excellent power density. The present invention remarkably improves the energy density in an electric double layer capacitor, a redox capacitor, a lithium ion electrolytic capacitor or an applied device thereof without damaging advantages such as high power density, high charge/discharge efficiency and long life.

### Means for Solving the Problems

The inventors have conducted a deep study, to find that a compound capable of performing a doping/dedoping reaction present in an electrolytic solution stores energy by performing a doping/dedoping reaction, and proposed the present invention.

The present invention relates to an energy storage device including a positive electrode, a negative electrode and an electrolytic solution, characterized in that a compound capable of performing a doping/dedoping reaction is present in the electrolytic solution.

Preferably, the concentration of the compound capable of performing a doping/dedoping reaction with respect to the electrolytic solution is at least 5 percent by weight.

Preferably, the compound capable of performing a doping/dedoping reaction is at least partially dissolved in the electrolytic solution.

Preferably, the electrolytic solution is a liquid at least including an ionic liquid.

Preferably, the electrolytic solution is a liquid further containing at least one solvent selected from the group consisting of acetonitrile, propylene carbonate, ethylene carbonate and γ-butyrolactone.

Preferably, the compound capable of performing a doping/dedoping reaction is a π-conjugate compound.

Preferably, the compound capable of performing a doping/dedoping reaction is a π-conjugate polymer.

Preferably, the compound capable of performing a doping/dedoping reaction is a π-conjugate compound having a number of carbon atoms of at least 14 and not more than 50.

Preferably, the compound capable of performing a doping/dedoping reaction is at least one compound selected from the group consisting of pyrene, naphthacene, chrysene, perylene, benzopyrene, coronene, helicene, pentacene and sexiphenyl and derivatives thereof.

Preferably, the positive electrode and the negative electrode are opposed to each other, the electrolytic solution is present between the positive electrode and the negative electrode, and an electrolytic solution free diffusion suppressing means suppressing free diffusion of the compound capable of performing a doping/dedoping reaction is present in the electrolytic solution between the positive electrode and the negative electrode.

Preferably, the electrolytic solution free diffusion suppressing means is a separator and/or an electrolytic membrane.

Preferably, the compound capable of performing a doping/dedoping reaction present in the electrolytic solution has a first energy storage means storing energy by performing a doping/dedoping reaction.

Preferably, the energy storage device further has a second energy storage means storing energy through electric double layer capacitance on the interfaces between the electrolytic solution and the electrodes.

Preferably, the energy storage device further has a third energy storage means storing energy through redox reactions of the electrodes.

Preferably, the energy storage device further contains lithium ions in the electrolytic solution, and has a fourth energy storage means storing energy through intercalation of the lithium ions into a carbon material forming the negative electrode.

Preferably, the energy storage device contains at least 50 mole percent in total of an N-doped n-type compound, a dedoped p-type compound, a dedoped pn-type compound and an N-doped pn-type compound with respect to the overall compound capable of performing a doping/dedoping reaction as compounds capable of performing a doping/dedoping reaction, when the ratio of the chargeable/dischargeable quantity of the positive electrode/the chargeable/dischargeable quantity of the negative electrode is at least 2.0.

Preferably, the energy storage device contains at least 50 mole percent in total of a P-doped p-type compound, a dedoped compound, a dedoped pn-type compound and a P-doped pn-type compound with respect to the overall compound capable of performing a doping/dedoping reaction as compounds capable of performing a doping/dedoping reaction, when the ratio of the chargeable/dischargeable quantity of the positive electrode/the chargeable/dischargeable quantity of the negative electrode is not more than 0.5.

Preferably, the energy storage device satisfies the conditions of the following formula:

−0.2≦(A−B−C+D+E−F)/(A+B+C+D+E+F+G)≦0.2

assuming that A represents the mole number of a P-doped p-type compound, B represents the mole number of a dedoped p-type compound, C represents the mole number of an N-doped n-type compound, D represents the mole number of a dedoped n-type compound, E represents the mole number of a P-doped pn-type compound, F represents the mole number of an N-doped pn-type compound, and G represents the mole number of a dedoped pn-type compound, as compounds capable of performing a doping/dedoping reaction when the ratio of the chargeable/dischargeable quantity of the positive electrode/the chargeable/dischargeable quantity of the negative electrode is greater than 0.5 and less than 2.0.

The present invention also relates to a method of manufacturing an energy storage device including a positive electrode, a negative electrode and an electrolytic solution, having the step of mixing a compound capable of performing a doping/dedoping reaction into the electrolytic solution.

Preferably, the method of manufacturing an energy storage device improves the chargeable/dischargeable quantity of the overall energy storage device by selecting the ratio of the compound capable of performing a doping/dedoping reaction in a doped state with respect to the overall compound capable of performing a doping/dedoping reaction and the classification of p-type/n-type/pn-type in response to the ratio between the chargeable/dischargeable quantities of the positive electrode and the negative electrode when mixing the compound capable of performing a doping/dedoping reaction into the electrolytic solution.

### Effects of the Invention

According to the present invention, an energy storage device having high energy density in addition to high power density, high charge/discharge efficiency and long life can be obtained. Energy density can be remarkably increased in an electric double layer capacitor, a redox capacitor, a lithium ion electrolytic capacitor or an applied device thereof, for example.

### BRIEF DESCRIPTION OF THE DRAWINGS

FIG. 1 shows CV spectra of 1-ethyl-3-methylimidazolium tosylate and 1-ethyl-3-methylimidazolium tosylate containing polyaniline dissolved therein.

FIG. 2 shows a charge/discharge curve of a bipolar cell employing 1-ethyl-3-methylimidazolium tosylate as an electrolytic solution.

FIG. 3 shows a charge/discharge curve of a bipolar cell employing 1-ethyl-3-methylimidazolium tosylate containing 1 part by weight of polyaniline dissolved therein as an electrolytic solution.

FIG. 4 shows a charge/discharge curve of a bipolar cell employing 1-ethyl-3-methylimidazolium tosylate containing 10 parts by weight of polyaniline dissolved therein as an electrolytic solution.

FIG. 5 shows a CV spectrum of a propylene carbonate solution of tetraethylammonium tetrafluoroborate containing pyrene.

FIG. 6 shows a charge/discharge curve of a platinum bipolar cell employing the propylene carbonate solution of tetraethylammonium tetrafluoroborate containing pyrene as an electrolytic solution.

FIG. 7 shows a CV spectrum of a chloroform solution of tetraethylammonium tetrafluoroborate containing coronene.

FIG. 8 shows a CV spectrum of a propylene carbonate solution of tetraethylammonium tetrafluoroborate containing iodobenzene.

FIG. 9 shows a CV spectrum of a propylene carbonate solution of tetraethylammonium tetrafluoroborate containing benzimidazole.

FIG. 10 shows a CV spectrum of a propylene carbonate solution of tetraethylammonium tetrafluoroborate containing quinoline.

FIG. 11 schematically illustrates a beaker cell employed for charge/discharge measurement.

FIG. 12 shows charge/discharge curves of comparative example 5 and Example 6.

FIG. 13 shows charge/discharge curves of Examples 5 to 7 and comparative example 5.

FIG. 14 is a graph showing electrostatic capacitance (F/m²) per electrode surface area (surface area of one electrode) of each of Examples 5, 8 and 9 and comparative examples 5 and 6 in the beaker cell.

### DESCRIPTION OF THE REFERENCE SIGNS

1 CV spectrum of 1-ethyl-3-methylimidazolium tosylate

2 CV spectrum of 1-ethyl-3-methylimidazolium tosylate containing 1 part by weight of polyaniline dissolved therein

3 CV spectrum of 1-ethyl-3-methylimidazolium tosylate containing 10 parts by weight of polyaniline dissolved therein

### BEST MODES FOR CARRYING OUT THE INVENTION

The inventors have found that an electrolytic solution region present between electrodes, having heretofore been not utilized as an energy storage means, can be utilized as an energy storage means, while transfer of charges in an electrode or an electric double layer around the electrode has generally been mainly utilized as the energy storage means in an energy storage device. The present invention solves such a conventional problem that energy density is low having generally been regarded as a problem to be solved in an electric double layer capacitor, a redox capacitor, a lithium ion electrolytic capacitor or an applied device thereof. While the present invention is now described in detail, the present invention is not restricted to the following.

The first of the present invention is an energy storage device including a positive electrode, a negative electrode and an electrolytic solution, characterized in that a compound capable of performing a doping/dedoping reaction is present in the electrolytic solution.

The compound capable of performing a doping/dedoping reaction present in the electrolytic solution functions as an energy storage means by performing a doping/dedoping reaction so that an electrolytic solution region having heretofore been not utilized as the energy storage means stores energy, whereby a larger quantity of energy can be stored, in addition to the conventional electrode energy storage means.

<Positive Electrode and Negative Electrode>

An electrode on a side where positive charges are stored in the electrode or around the same at the time of charge is referred to as the positive electrode, and an electrode on a side where negative charges are stored in the electrode or around the same at the time of charge is referred to as the negative electrode. A single electrode can act both as the positive electrode and the negative electrode depending on the device such as an electric double layer capacitor, and hence the single electrode may not necessarily invariably be the positive electrode or the negative electrode. Also in this case, however, a second electrode acts as the negative electrode if a first electrode acts as the positive electrode in a certain instant, and hence the electrodes are referred to as “the positive electrode and the negative electrode” including this case.

<Electrolytic Solution>

The electrolytic solution according to the present invention contains a compound capable of storing energy by doping/dedoping.

While the compound capable of performing a doping/dedoping reaction may be either dispersed or dissolved in the electrolytic solution, the same is preferably dissolved, as described later. If a compound having a high molecular weight is employed as the compound capable of performing a doping/dedoping reaction, therefore, a solvent capable of dissolving this compound performing a doping/dedoping reaction is preferably employed.

While an ordinary organic solvent can be used as the solvent for the electrolytic solution if the compound capable of performing a doping/dedoping reaction is employed in a dispersed manner or a compound having a relatively small molecular weight is employed as the compound capable of performing a doping/dedoping reaction, acetonitrile, propylene carbonate, ethylene carbonate or γ-butyrolactone is preferably employed in such a point of view that the same can dissolve an electrolyte (ions serving as a dopant) in high concentration and has a wide potential window.

In place of dissolving the electrolyte in the solvent, an ionic liquid (cold-molten salt) constituted of only ions at ordinary temperature without containing a solvent can be utilized. The ionic liquid has ion concentration increasable beyond that of an ordinary electrolytic solution, does not evaporate and exhibits no flammability, and hence the same has properties preferable to be applied to an energy device.

When an ionic liquid is employed, a mixture of the ionic liquid and an organic solvent is preferably employed in view of properly balancing high ion concentration and high electric conductivity.

The concentration of the compound capable of doping/dedoping in the electrolytic solution is desirably higher, in order to improve the energy density of the energy storage device. While the compound capable of doping/dedoping may be either dissolved or dispersed in the electrolytic solution, the same is desirably dissolved in the electrolytic solution so that the same can easily penetrate into deep portions of pores of the electrodes if porous electrodes are employed.

<Energy Storage Device>

The energy storage device mentioned in the present invention is a device capable of storing energy by an electrochemical reaction, chemical adsorption, physical adsorption or the like, and includes a secondary cell, an electrolytic capacitor, an electric double layer capacitor, a redox capacitor by an oxide, a π-conjugate polymer or π-conjugate molecules, a lithium ion electrolytic capacitor or the like.

<Compound Capable of Performing Doping/Dedoping Reaction>

The compound capable of performing a doping/dedoping reaction mentioned in the present invention is a compound capable of causing an electrochemically reversible doping/dedoping reaction in the electrolytic solution. For example, a π-conjugate polymer or π-conjugate molecules employed in the present invention can be listed.

The second of the present invention is the energy storage device according to the aforementioned first invention, characterized in that the concentration of the compound capable of performing a doping/dedoping reaction with respect to the electrolytic solution is at least 5 percent by weight and not more than 95 percent by weight.

<Concentration of Compound Capable of Performing Doping/Dedoping Reaction in Electrolytic Solution>

The compound capable of performing a doping/dedoping reaction in the electrolytic solution must have at least a certain degree of concentration, since sufficient energy cannot be stored in the region of the electrolytic solution if the concentration is excessively low. In order to effectively increase the quantity of energy storage, the concentration of the compound capable of performing a doping/dedoping reaction is desirably at least 5 percent by weight and not more than 95 percent by weight.

The third of the present invention is the energy storage device according to the aforementioned first or second invention, characterized in that the compound capable of performing a doping/dedoping reaction is at least partially dissolved in the electrolytic solution.

<Dissolution>

Dissolution means that the compound forms a homogeneous mixture with the solvent at the molecular level. Even in a state not dissolved but dispersed in the electrolytic solution, the compound in a dedoped state can be converted to a doped state by application of a voltage, and the compound in the doped state can also be converted to the dedoped state. However, it is generally difficult to maintain a dispersed state over a long period and the operation may be destabilized as compared with the case where the compound is dissolved, and hence the electrolytic solution preferably dissolves the compound capable of performing a doping/dedoping reaction. If porous electrodes are employed, the compound is preferably dissolved in the electrolytic solution as well, so that the compound capable of performing a doping/dedoping reaction which is an active material can easily penetrate into the pores of the electrodes. While the quantity of storable energy increases as the concentration of the compound capable of performing a doping/dedoping reaction in the electrolytic solution increases, viscosity generally so increases that conductivity of the electrolytic solution lowers and the response speed of the element reduces, and hence proper concentration is present. Concentration of at least 5 percent by weight and not more than 70 percent by weight is desirable, depending on the design of the element.

The fourth of the present invention is the energy storage device according to any of the aforementioned first to third inventions, characterized in that the electrolytic solution is a liquid at least including an ionic liquid.

<Ionic Liquid>

The ionic liquid is a salt keeping a liquid state at ordinary temperature, and various compounds are present. An atomic group having a cationic component of an imidazolium derivative, an ammonium derivative, a pyridinium derivative or a phosphonium derivative and an anionic component such as BF₄⁻ or PF₆⁻ containing fluorine, an atomic group having a sulfonate anion, an atomic group having an anionic component containing carboxylato (—COO) and the like are typically known. Such an ionic liquid entirely constituted of an ionic atomic group exhibits ion conductivity, has ion concentration increasable beyond that of an ordinary electrolytic solution, does not evaporate and has no flammability, whereby the same can be preferably employed as the electrolytic solution.

In particular, an ionic liquid such as 1-ethyl-3-methylimidazolium tetrafluoroborate, 1-butyl-3-methylimidazolium tetrafluoroborate, 1-ethyl-3-methylimidazolium hexafluorophosphate, 1-butyl-3-methylimidazolium hexafluorophosphate, 1-ethyl-3-methylimidazolium tosylate or 1-butyl-3-methylimidazolium tosylate in which an ability to store a large quantity of charges by doping/dedoping and excellent repetition stability of doping/dedoping are obtained can be preferably used for the electrolytic solution according to the present invention.

The ionic liquid is preferable as the electrolytic solution also in view of dissolving the compound capable of doping/dedoping. For example, a π-conjugate polymer which is an example of the compound capable of performing a doping/dedoping reaction is generally known as insoluble/infusible, and has low solubility in a general solvent. As a result of a study conducted by the inventors, however, it has been recognized that the ionic liquid can dissolve a large quantity of π-conjugate polymer. It is effective to employ the ionic liquid as the solvent for the electrolytic solution, for forming a π-conjugate polymer electrolytic solution of high concentration.

Further, not only the ionic liquid but also another support electrolyte such as tetraethylammonium tetrafluoroborate can be dissolved and employed, or another solvent such as acetonitrile can also be mixed and employed. However, the solubility of the π-conjugate polymer lowers if a mixture of the ionic liquid is employed for the electrolytic solution, and hence the ionic liquid preferably occupies at least 30 percent by weight, preferably at least 80 percent by weight of the electrolytic solution components.

The fifth of the present invention is the energy storage device according to the aforementioned fourth invention, characterized in that the electrolytic solution is a liquid further containing at least one solvent selected from the group consisting of acetonitrile, propylene carbonate, ethylene carbonate and γ-butyrolactone.

<Organic Solvent>

Among organic solvents, acetonitrile, propylene carbonate, ethylene carbonate or γ-butyrolactone having a wide potential window and low viscosity is preferable as the solvent used for the electrolytic solution. This organic solvent forms a homogeneous mixed solution with the ionic liquid at an extremely wide mixing ratio so that an electrolytic solution having a high withstand voltage and high electric conductivity can be prepared, whereby the organic solvent is preferable also in view of employing the same for the electrolytic solution as a mixed solution with the ionic liquid.

<Mixture of Ionic Liquid and Organic Solvent>

The mixed solution of the ionic liquid and the organic solvent is prepared by adding the organic solvent to the ionic liquid and stirring the mixture. Alternatively, the mixed solution may be prepared by adding the ionic liquid to the organic solvent. While it may take time to homogeneously mix the ionic liquid and the organic solvent with each other depending on the combination and the mixing ratio thereof, a homogeneous mixed solution can be obtained in most cases when generally stirring the mixture for about one hour. Contamination of the electrolytic solution with moisture must be prevented depending on the application of the electrolytic such as an electrolytic solution for a capacitor charged/discharged at a high voltage, and it may be necessary to mix the ionic liquid and the organic solvent with each other in an atmosphere of nitrogen gas or argon gas. While the organic solvent must be mixed in order to reduce the viscosity of the ionic liquid, the ion concentration of the mixed solution is to be increased and hence it is unpreferable to excessively mix the organic solvent. While it is generally most desirable to mix the ionic liquid and the organic solvent with each other at a mixing ratio maximizing the electric conductivity of the mixed solution, a mixed solution having sufficient electric conductivity can be prepared and can be excellently used for the purpose of the present invention even if the ionic liquid and the organic solvent are mixed with each other at an arbitrary ratio, if the ratio (volume ratio) is within such a range that the content of the ionic liquid is within ±50% from the mixing ratio maximizing the electric conductivity. A mixed solution of the ionic liquid and the organic solvent mixed at a ratio within this range can be widely used as an electrolytic solution for an electrochemical element, and it is hardly apprehended that the response speed of the electrochemical element is damaged. If the ratio is out of this range, the electrolytic solution disadvantageously acts with respect to the response speed of the electrochemical element even if the ion concentration of the electrolytic solution can be remarkably increased, for example, and is inferior in practicality unless the same is usable on a slow application side. When a mixed solution prepared at a mixing ratio within the aforementioned range is employed as an electrolytic solution for an electric double layer capacitor or a redox capacitor, for example, both of electrostatic capacitance and a charge/discharge speed can be improved as compared with a case of employing a conventional electrolytic solution. A more desirable mixing ratio is a ratio (volume ratio) within such a range that the content of the ionic liquid is within ±20% from the mixing ratio maximizing the electric conductivity, and a further desirable mixing ratio is a ratio (volume ratio) within such a range that the content of the ionic liquid is within ±10% from the mixing ratio maximizing the electric conductivity. The aforementioned preferable mixing ratio is generally within the range of ionic liquid:organic solvent=1:5 to 5:1 (volume ratio). Acetonitrile, propylene carbonate, ethylene carbonate or γ-butyrolactone can be preferably employed for preparing such a mixture.

The sixth of the present invention is the energy storage device according to any of the aforementioned first to fifth inventions, characterized in that the compound capable of performing a doping/dedoping reaction is a π-conjugate compound.

<π-Conjugate Compound>

The compound capable of performing a doping/dedoping reaction employed in the present invention, not particularly limited, is preferably π-conjugate compound obtainable at a relatively low cost and relatively easily dissolvable in the electrolytic solution. As the π-conjugate compound, a conductive polymer such as polythiophene, polyaniline, polypyrrole or polyparaphenylene which is a typical conductive polymer or a derivative thereof, an oligomer of such a conductive polymer or a derivative thereof, or naphthacene (tetracene), chrysene, pyrene, pentacene, benzopyrene, perylene, helicene, p-sexiphenyl or coronene which is a π-conjugate molecule can be listed. The oligomer denotes a substance obtained by polymerizing 2 to 20 monomer molecules. A fullerene such as C₆₀ or a derivative thereof can also be utilized. However, the π-conjugate compound is not particularly limited so far as the same performs reversible doping/dedoping. A mixture containing a plurality of such compounds and derivative thereof can also be excellently used in the present invention.

A compound capable of more largely performing doping is preferable as the used π-conjugate compound in view of increasing the capacitance of the energy storage device, and the capacitance can be remarkably increased by properly selecting the combination of the π-conjugate compound and the type of a dopant.

While the π-conjugate compound employed in the present invention stores energy by performing doping or dedoping itself, the π-conjugate compound in formation of the energy storage device may be either in a doped state or in a dedoped state, and may be only partially doped if necessary, as described later.

The seventh of the present invention is the energy storage device according to any of the aforementioned first to fifth inventions, characterized in that the compound capable of performing a doping/dedoping reaction is a π-conjugate polymer.

The compound capable of performing a doping/dedoping reaction employed in the present invention is not particularly limited. However, an energy storage device capable of high-speed charge/discharge with relatively long life can be prepared when employing a π-conjugate polymer exhibiting stable and high-speed doping/dedoping behavior, and hence it is desirable to use the π-conjugate polymer.

<π-Conjugate Polymer>

While the π-conjugate polymer mentioned here is not particularly limited so far as the same is a polymer having a π-conjugate main chain, that having a number-average molecular weight of at least 1000 is preferable. More preferably, the number-average molecular weight is at least 1500 and not more than 100000. When expressed in the number of bonds of raw monomers, a compound having at least 21 bonded raw monomers is preferable. While a conductive polymer such as polythiophene, polyaniline, polypyrrole or polyparaphenylene which is a typical conductive polymer or a derivative thereof, for example, can be efficiently utilized as the π-conjugate polymer, the polymer is not particularly limited so far as the same performs reversible doping/dedoping. A mixture containing a plurality of such compounds and derivative thereof can also be excellently used.

When porous electrodes are employed, it may be preferable to introduce substituent groups such as alkyl groups, nitro groups or sulfonic acid groups so that the polymer is easily dissolvable in the solvent, in order to easily introduce the π-conjugate polymer which is an active material into the pores of the electrodes.

The eighth of the present invention is the energy storage device according to any of the aforementioned first to fifth inventions, characterized in that the compound capable of performing a doping/dedoping reaction is a π-conjugate compound having a number of carbon atoms of at least 14 and not more than 50.

<Combination of π-Conjugate Polymer and Organic Solvent or Ionic Liquid>

While a π-conjugate polymer is generally hard to disperse or dissolve in an organic solvent, the π-conjugate polymer is more homogeneously present in the electrolyte to remarkably attain the effects of the present invention when the combination thereof is properly selected. As a preferable combination, poly-3-alkylthiophene (the carbon number of alkyl groups is desirably 3 to 12) and tetrahydrofuran and chloroform or poly-3-nitrothiophene and propylene carbonate can be listed. An electrolyte prepared by properly combining the π-conjugate polymer and the organic solvent with each other is so employed as to advantageously widen the potential window and increase the electric conductivity.

The π-conjugate polymer can be introduced into the electrolyte also by properly selecting the combination with the ionic liquid: As a preferable combination, 1-ethyl-3-methylimidazolium tosylate or 1-ethyl-3-methylimidazolium tetrafluoroborate and polyaniline or a derivative thereof, polythiophene or a derivative thereof, plypyrrole or a derivative thereof or polyparaphenylene or a derivative thereof can be listed. When the ionic liquid is employed, the ion concentration is advantageously increased beyond that of an ordinary electrolytic solution. In this case, the ionic liquid is preferably mixed with an organic solvent in order to attain the target electric conductivity.

Whether to employ an organic solvent, to employ an ionic liquid or to employ an ionic liquid and an organic solvent in a mixed state may be selected in response to the type of the employed π-conjugate polymer and the target effects.

<π-Conjugate Compound Having Number of Carbon Atoms of at Least 14 and Not More Than 50>

In the present invention, not only a polymer but also a compound having a relatively low molecular weight can be employed as the π-conjugate compound. In particular, no such recognition has heretofore been found that even a compound having a relatively low molecular weight can be utilized for power storage by repetitively causing a doping/dedoping reaction, and it is unpredictable for those skilled in the art to increase the capacitance by utilizing this. Further, a compound having a low molecular weight can advantageously be easily introduced into the pores of porous electrodes, as described later. As to the π-conjugate compound having a relatively low molecular weight, the number of carbon atoms is preferably at least 14 and not more than 50. While a π-conjugate compound having relatively small bulk may be inferior in stability of doping/dedoping depending on the type thereof, this compound can be more easily introduced into the pores of a porous electrode of active carbon or the like than a polymer in a state dissolved in an electrolytic solution, and hence the same may be extremely preferable as an active material when porous electrodes are employed. The π-conjugate compound mentioned here indicates not only a single π-conjugate molecule, but also includes an oligomer of the π-conjugate polymer. As an example of such an oligomer, a lower polymer (dimer, trimer, tetramer, pentamer, hexamer, septmer or the like) of thiophene, aniline, pyrrole or benzene or a derivative thereof can be excellently utilized. A mixture containing a plurality of such lower polymers or derivatives thereof can also be excellently used.

As to the π-conjugate compound, chrysene or pyrene can be employed as the π-conjugate compound, in addition to naphthacene (tetracene), for example. Further, pentacene, benzopyrene or perylene can be employed, and helicene, p-sexiphenyl or coronene can also be employed as a large one. Further, the π-conjugate compound may be a derivative thereof, or a mixture containing a plurality of such compounds or derivatives thereof.

These molecules are preferably present around the surfaces of the electrodes in a number as large as possible, and hence pyrene or coronene more densely pack able as compared with straight-chain molecules of the same molecular weight is conceivably advantageous in a case of electrodes of active carbon or the like having complicated surface shapes.

It is of course possible to introduce various functional groups into the aforementioned π-conjugate compound. Not only the energy of a doping/dedoping reaction or the capacitance can be changed but also dissolubility with respect to the solvent can be changed by introducing the functional groups. For example, dissolubility with respect to a polar solvent can be increased by introducing alkyl groups, nitro groups or sulfonic acid groups. Further, it is also possible to partially replace carbon of the main skeleton by nitrogen or carbonyl groups. For example, quinacridone having a shape obtained by replacing two carbon atoms of pentacene by nitrogen and introducing two carbonyl groups can also used for the present invention.

In this π-conjugate compound, the range of alternatives to the dissolvable solvent so widens as compared with a case of dissolving the same π-conjugate polymer that the same can be relatively easily dissolved in THF, NMP or trichloromethane, in addition to the ionic liquid.

Such a π-conjugate compound is generally on the market as powder at a relatively low price, and has superior solvent dissolubility as compared with the π-conjugate polymer. The number of carbon atoms of the π-conjugate compound is preferably at least 14 in view of stably causing reversible doping/dedoping. If the number of carbon atoms in a molecule is less than 14, it is difficult to induce a doping/dedoping reaction under a general voltage application condition. The electrolytic solution is decomposed if a voltage is applied in excess of the general voltage application condition (±2.5 volts for Ag/Ag+ electrode). If the number of carbon atoms contained in one molecule is at least 51, the quantity of the π-conjugate compound dissolvable in the electrolytic solution is remarkably restricted. The bulk is preferably not large in view of smoothly introducing the active material into the pores of the electrodes, and the number of carbon atoms is preferably not more than 50 also in this point. Proper substituent groups such as alkyl groups, nitro groups or sulfonic acid groups are desirably introduced so that the compound is easily dissolvable in the solvent in a point of view similar to that related to the π-conjugate polymer.

The ninth of the present invention is the energy storage device according to any of the aforementioned first to fifth inventions, characterized in that the compound capable of performing a doping/dedoping reaction is at least one compound selected from the group consisting of pyrene, naphthacene, chrysene, perylene, benzopyrene, coronene, helicene, pentacene and sexiphenyl and derivatives thereof.

<Preferably Usable π-Conjugate Molecule>

Among the aforementioned examples of the π-conjugate compound having the number of carbon atoms of at least 14 and not more than 50, pyrene, naphthacene, chrysene, perylene, benzopyrene, coronene, helicene, pentacene or sexiphenyl can perform a doping/dedoping reaction in the electrolytic solution, has such properly small bulk that the same can be easily introduced also into the pores of a porous electrode of active carbon or the like, and can be preferably used for the object of the present invention.

The tenth of the present invention is the energy storage device according to any of the aforementioned first to ninth inventions, characterized in that the positive electrode and the negative electrode are opposed to each other, the electrolytic solution is present between the positive electrode and the negative electrode, and an electrolytic solution free diffusion suppressing means suppressing free diffusion of the compound capable of performing a doping/dedoping reaction is present in the electrolytic solution between the positive electrode and the negative electrode.

<Electrolytic Solution Free Diffusion Suppressing Means Suppressing Free Diffusion>

The energy storage device according to the present invention has at least two electrodes, and stores energy by causing a potential difference between the electrodes. However, energy stored by doping/dedoping of the compound in the electrolytic solution is lost if the compound capable of doping/dedoping separates from around the electrodes by free diffusion after charge, and hence an electrolytic solution free diffusion suppressing means for preventing homogenization of charges in the solution is necessary. Free diffusion of the electrolytic solution around the electrodes can be suppressed to some extent by using porous electrodes of active carbon or the like, for example.

The eleventh of the present invention is the energy storage device according to the aforementioned tenth invention, characterized in that the electrolytic solution free diffusion suppressing means is a separator and/or an electrolytic membrane.

<Separator>

The energy storage device according to the present invention has at least two electrodes, and stores energy by causing a potential difference between the electrodes. Discharge takes place and storage efficiency lowers if a means of electronic conduction is present between the electrodes, and hence a separator is generally interposed between the electrodes in order to prevent the electrodes from coming into contact with each other. This separator present to be in contact with the electrodes has an effect of suppressing free diffusion of the electrolytic solution around the electrodes as such, and hence the same is preferably used for the energy storage device according to the present invention.

<Electrolytic Membrane>

An electrolytic membrane can also be utilized for the object of suppressing free diffusion of the electrolytic solution in addition to a general paper separator employing synthetic cellulose fiber or the like. The electrolytic membrane is capable of ion transference and has an effect of preventing homogenization of in-liquid charges, and hence the same can be excellently employed for the present invention.

The twelfth of the present invention is the energy storage device according to any of the aforementioned first to eleventh inventions, characterized in that the compound capable of performing a doping/dedoping reaction present in the electrolytic solution has a first energy storage means storing energy by performing a doping/dedoping reaction.

<First Energy Storage Means>

The inventors have found that the compound present in the electrolytic solution can store energy by performing a doping/dedoping reaction. This is referred to as the first energy storage means. The first energy storage means in the energy storage device according to the present invention is characterized in that at least one compound present in the electrolytic solution stores energy by performing a doping/dedoping reaction. While the compound mentioned here is not particularly limited so far as the same can store energy by performing a doping/dedoping reaction, a π-conjugate compound such as a π-conjugate molecule or a π-conjugate polymer is preferable. Energy can be stored in the region of the electrolytic solution having been not utilized in general, and the quantity of stored energy can be increased. Two examples are now described.

### EXAMPLE 1

### Electrodes Have No Power Storage Function and Compound Contained in Electrolytic Solution Can Be p-Doped

In this case, a partial compound (mainly present around one of the electrodes) of the electrolytic solution is p-doped, while another partial compound (mainly present around the electrode opposed to the electrode) in a p-doped state is dedoped to be charged. A reverse reaction takes place to cause discharge. The same system can be constituted in principle also when the compound in the electrolytic solution can only be n-doped.

### EXAMPLE 2

### Electrodes Have No Power Storage Function and π-Conjugate Molecules Contained in Electrolytic Solution Can Be pn-Bidoped

In this case, a partial compound (mainly present around one of the electrodes) of the electrolytic solution is p-doped, while another partial compound (mainly present around the electrode opposed to the electrode) is n-doped to be charged. The doped compounds are dedoped respectively to cause discharge.

<p-Doping>

This denotes doping (p-doping) in such a state that the compound itself is oxidized and positively charged and anions approach the compound to counteract the charges so that the compound is neutralized and stabilized as a whole. A compound causing this type of doping/dedoping is referred to as a p-type compound. Polyaniline, polypyrrole or poly-(3,4-ethylenedioxy) thiophene can be listed as the p-type compound.

<n-Doping>

This denotes doping (n-doping) in such a state that the compound itself is reduced and negatively charged and cations approach the compound to counteract the charges so that the compound is neutralized and stabilized as a whole. A compound causing this type of doping/dedoping is referred to as an n-type compound.

<pn-Bidoping>

The aforementioned p-doping and n-doping are combinedly referred to as pn-bidoping. A compound capable of pn-bidoping is referred to as a pn-type compound. Poly-3-(4-fluorophenyl) thiophene, poly-3-(4-trifluoromethylphenyl) thiophene or poly-3-(2,4-difluorophenyl) thiophene can be listed as the pn-type compound.

The thirteenth of the present invention is the energy storage device according to the aforementioned twelfth invention, characterized in that the device further has a second energy storage means storing energy through electric double layer capacitance on the interfaces between the electrolytic solution and the electrodes.

<Second Energy Storage Means>

A method of storing energy through electric double layer capacitance on the interfaces between the electrolytic solution and the electrodes is referred to as the second energy storage means. An example of the present invention is an electric double layer capacitor having this second energy storage means and a doping/dedoping reaction (first energy storage means) of the compound contained in the electrolytic solution. The most typical electrodes employed for the device according to the present invention are made of active carbon. The double layer capacitance generally increases in proportion to the surface area. A substance obtained by activating carbon black such as acetylene black for increasing the surface area is solidified with a binder such as polyvinylidene fluoride (PVDF). The compound capable of doping/dedoping is so employed for part of the electrolytic solution that energy storage results from a doping/dedoping reaction of the compound in the electrolytic solution and the quantity of energy stored in the device increases in addition to ordinary energy storage through the electric double layer capacitance. The energy storage through the electric double layer capacitance has a high charge/discharge speed, and hence an energy storage device having an excellent charge/discharge speed and a relatively large quantity of energy storage can be created by combining this with energy storage through a doping/dedoping reaction of a compound in the electrolytic solution. Two examples are now described.

### EXAMPLE 3

### Electrodes Have Power Storability as Electric Double Layer and Compound Contained in Electrolytic Solution Can Be p-Doped

In this case, a partial compound (mainly present around one of the electrodes) of the electrolytic solution is p-doped while another partial compound (mainly present around the electrode opposed to the electrode) in a p-doped state is dedoped to be charged, in addition to power storage as an ordinary electric double layer capacitor. This also applies to discharge, and a reverse reaction of the compound contained in the electrolytic solution and discharge of the electric double layer capacitor are performed. The same system can be constituted in principle also when the compound in the electrolytic solution can only be n-doped.

### EXAMPLE 4

### Electrodes Have Power Storability as Electric Double Layer and Compound Contained in Electrolytic Solution Can Be pn-Bidoped

In this case, a partial compound (mainly present around one of the electrodes) of the electrolytic solution is p-doped while another partial compound (mainly present around the electrode opposed to the electrode) is n-doped to be charged, in addition to power storage as an ordinary electric double layer capacitor. The doped compounds are dedoped respectively at the time of discharge.

The fourteenth of the present invention is the energy storage device according to the aforementioned twelfth or thirteenth invention, characterized in that the device has a third energy storage means storing energy through redox reactions of the electrodes.

<Third Energy Storage Means>

An operation of storing energy through a doping/dedoping reaction of an electrode is referred to as the third energy storage means. A metallic oxide such as ruthenium oxide, iridium oxide, tungsten oxide, molybdenum oxide or copper oxide or a π-conjugate polymer such as polyacene or a polythiophene derivative can be listed as the electrodes therefor. A capacitor employing these electrodes can store energy following doping/dedoping reactions of the electrodes. A doping/dedoping reaction of the compound contained in the electrolytic solution is further employed for energy storage, whereby energy storage resulting from the doping/dedoping reaction of the compound in the electrolytic solution takes place in addition to energy storage of an ordinary redox capacitor, and the quantity of energy stored in the device can be increased. The quantity of energy storage can be relatively increased in energy storage by the doping/dedoping reactions of the electrodes, and hence an energy storage device having a large quantity of energy storage can be created by combining this with the energy storage by the doping/dedoping reaction of the compound in the electrolytic solution. Two examples are now described.

### EXAMPLE 5

### Electrodes Have Charge Storability as Electrodes for Redox Capacitor and Compound Contained in Electrolytic Solution Can Be p-Doped

In this case, a partial compound (mainly present around one of the electrodes) of the electrolytic solution is p-doped while another partial compound (mainly present around the electrode opposed to the electrode) in a p-doped state is dedoped to be charged, in addition to power storage as an ordinary redox capacitor. This also applies to discharge, and a reverse reaction of the compound contained in the electrolytic solution and discharge of the redox capacitor are performed.

### EXAMPLE 6

### Electrodes Have Power Storability as Electrodes for Redox Capacitor and π-Conjugate Molecules Contained in Electrolytic Solution Can Be pn-Bidoped

A partial compound (mainly present around one of the electrodes) of the electrolytic solution is p-doped while another partial compound (mainly present around the electrode opposed to the electrode) is n-doped to be charged. Dedoping of the compound in the doped state in the electrolytic solution and discharge of the redox capacitor are performed in the case of discharge.

The fifteenth of the present invention is the energy storage device according to any of the aforementioned twelfth to fourteenth inventions, characterized in that the device further contains lithium ions in the electrolytic solution, and has a fourth energy storage means storing energy through intercalation of the lithium ions into a carbon material forming the negative electrode.

<Fourth Energy Storage Means>

An operation of storing energy through intercalation of the lithium ions into a carbon material such as graphite forming the negative electrode is referred to as the fourth energy means. While a substance utilizing an electric double layer between an active carbon electrode and the electrolytic solution or a substance utilizing a doping/dedoping reaction of a π-conjugate polymer electrode, for example, can be listed as the positive electrode, the material is not restricted to this. At least the electrolytic solution contains a compound capable of doping/dedoping with lithium ions (dissolve LiPF₆, for example). Also in this case, energy storage can be performed through a doping/dedoping reaction of the compound in the electrolytic solution in addition to energy storage as an ordinary lithium ion electrolytic capacitor, whereby the quantity of energy storage can be increased. In particular, the charge/discharge voltage and energy density of the lithium ion electrolytic capacitor can be increased due to the low potential of the negative electrode, whereby a high energy density type energy storage device can be prepared by further adding the energy storage resulting from the doping/dedoping reaction of the compound in the electrolytic solution.

For example, the positive electrode is constituted of a material such as active carbon performing power storage with electric double layer capacitance, and the negative electrode is made of a material such as graphite capable of storing power through intercalation of lithium ions. If the thing is left as it is, the quantity of power storage cannot be much increased in the device as a whole since the capacitance of the positive electrode is small as compared with the negative electrode. In this case, the compound capable of a doping/dedoping reaction is properly added to the electrolytic solution, so that the electric double layer capacitance of the positive electrode can be supplemented with respect to the overwhelmingly large capacitance of the negative electrode, and the quantity of power storage of the overall device can be increased.

The sixteenth of the present invention is the energy storage device according to any of the aforementioned first to fifteenth inventions, characterized in that the device contains at least 50 mole percent in total of an n-doped n-type compound, a dedoped p-type compound, a dedoped pn-type compound and an n-doped pn-type compound with respect to the overall compound capable of performing a doping/dedoping reaction as compounds capable of performing a doping/dedoping reaction, when the ratio of the chargeable/dischargeable quantity of the positive electrode/the chargeable/dischargeable quantity of the negative electrode is at least 2.0.

<Doped State>

In the doped state, the compound itself is oxidized or reduced to be positively or negatively charged and anions or cations are present around the π-conjugate compound to counteract the charges so that the compound is neutralized and stabilized as a whole.

The aforementioned anions and cations are supplied from anions and cations contained in the electrolytic solution in a doping/dedoping reaction in the electrolytic solution. While BF₄⁻, PF₆⁻, ClO₄⁻, organic sulfonate ions, sulfate ions or (CF₃SO₂)₂N⁻, for example, can be employed as the anions contained in the electrolytic solution and various quaternary ammonium cations, pyridinium cations, imidazolium cations,. Li⁺ or Na⁺ can be employed as the cations contained in the electrolytic solution, the materials are not restricted to these.

For example, BF₄⁻, PF₆⁻, ClO₄⁻, iodine, organic sulfonate ions, sulfate ions, (CF₃SO₂)₂N⁻, various quaternary ammonium cations, various pyridinium cations, various imidazolium cations, Li⁺ or Na⁺ can be employed as the dopant for the compound in the doped state and the material is not particularly restricted, a material capable of more largely doping the used compound is preferable in view of increasing the capacitance of the energy storage device, and it is desirable to render the ions (dopant) contained in the electrolytic solution common to this.

As the compound in the doped state, powdery polyaniline containing p-toluenesulfonate anions as the dopant, polypyrrole or polythiophene or a derivative thereof can be listed, for example. Membranous polythiophene (containing BF₄⁻ or PF₆⁻ as the dopant) obtained by electrolytic polymerization or the like can also be listed as an example. The compound in the doped state added to the electrolytic solution is preferably dissolved in the used electrolytic solution in higher concentration or preferably creates a more stable dispersion in view of increasing the capacitance of the energy storage device.

In general, the compound can be regarded as in a doped state if the same is even slightly doped with the dopant. The “doped” mentioned in the sixteenth to the twentieth of the present invention is preferably such a state that the compound is almost maximumly doped in a range capable of repetitively performing electrochemically stable doping/dedoping, and such a state that the dopant is introduced by 100 to 50% as compared with the quantity of the dopant maximumly introducible in the range capable of repetitively performing electrochemically stable doping/dedoping is referred to as the “doped” state. For example, such a state that one (one charge) dopant is introduced with respect to eight to four thiophene monomer units is referred to as the “doped” state in relation to thiophene.

<Dedoped State>

The dedoped state of the compound denotes such a state that the compound itself is not oxidized or reduced but remains electrically neutral. As the compound in the dedoped state to be added to the electrolytic solution, powdery polyaniline, polypyrrole or polythiophene or a derivative thereof, for example, can be listed. A substance prepared by electrochemically dedoping membranous polythiophene (containing BF₄⁻ or PF₆⁻ as the dopant) or the like obtained by electrolytic. polymerization can also be listed as an example. The compound in the dedoped state contained in the electrolytic solution is preferably dissolved in the used electrolytic solution in higher concentration or preferably creates a more stable dispersion in view of increasing the capacitance of the energy storage device.

In general, the compound can be regarded as in a doped state if the same is even slightly doped with the dopant. However, the “dedoped” mentioned in the sixteenth to the twentieth of the present invention may be a state doped with a small quantity of dopant in view of effectively increasing the charge/discharge quantity of the energy storage device. The compound is of course preferably in a completely dedoped state, such a state that the dopant is introduced by 0 to 30% as compared with the quantity of the dopant maximumly introducible in the range capable of repetitively performing electrochemically stable doping/dedoping is referred to as the “dedoped” state. For example, such a state that one (one charge) dopant is introduced with respect to at least 12 thiophene monomer units is referred to as the “dedoped” state in relation to polythiophene.

<Chargeable/Dischargeable Quantity>

The quantity of charges capable of repetitively charging/discharging each electrode or the energy storage device is referred to as the chargeable/dischargeable quantity. In a conventional energy storage device not storing charges by redox of the compound in the electrolytic solution dissimilarly to the present invention, the chargeable/dischargeable quantity of the energy storage device is defined by the chargeable/dischargeable quantity of the electrode having a smaller chargeable/dischargeable quantity in the two electrodes.

<Supplement Chargeable/Dischargeable Quantity on Side of Negative Electrode with Compound Capable of Performing Doping/Dedoping Reaction in Electrolytic Solution>

If the chargeable/dischargeable quantities of the positive electrode and the negative electrode are 100 and 50 respectively as in the aforementioned sixteenth of the present invention, for example, the chargeable/dischargeable quantity of the overall energy storage device is 50. While various methods are conceivable in order to improve the energy density of the energy storage device, it is extremely effective to increase the chargeable/dischargeable quantity as in the present invention. In order to effectively improve the chargeable/dischargeable quantity of the energy storage device, the capacitance on the side of the electrode having the smaller chargeable/dischargeable quantity may be preferentially increased so that the electrodes have the same capacitance levels. In the aforementioned example, for example, the chargeable/dischargeable quantity of the overall energy storage device can be set to 100 by increasing the capacitance on the side of the negative electrode by 50 to reach 100. If the capacitance on the side of the negative electrode is increased by 80 to reach 130 and the capacitance on the side of the positive electrode is increased by 30 to reach 130 in the aforementioned example, the chargeable/dischargeable quantity of the overall energy storage device can be set to 130, and it follows that the chargeable/dischargeable quantity of the overall energy storage device is most efficiently increased in this case.

Such efficient increase of the chargeable/dischargeable quantity of the energy storage device can be implemented by successfully selecting the ratio between the doped state and the dedoped state of the compound added to the electrolytic solution and the type (p-type, n-type or pn-type) of the compound. In the case of the aforementioned sixteenth of the present invention, for example, the chargeable/dischargeable quantity of the energy storage device can be effectively increased by supplementing the chargeable/dischargeable quantity of the negative electrode, and hence it is important to preferentially increase the quantity of power storage on the side of the negative electrode. Therefore, the electrolytic solution desirably contains a large quantity of (at least 50 mole percent with respect to the overall compound capable of performing a doping/dedoping reaction) of compounds in a state supplementing the quantity of power storage on the side of the negative electrode while not increasing the quantity of power storage on the side of the positive electrode, i.e., an n-doped n-type compound, a dedoped p-type compound, a dedoped pn-type compound and an n-doped pn-type compound.

The seventeenth of the present invention is the energy storage device according to any of the aforementioned first to fifteenth inventions, characterized in that the device contains at least 50 mole percent in total of a p-doped p-type compound, a dedoped n-type compound, a dedoped pn-type compound and a p-doped pn-type compound with respect to the overall compound capable of performing a doping/dedoping reaction as compounds capable of performing a doping/dedoping reaction, when the ratio of the chargeable/dischargeable quantity of the positive electrode/the chargeable/dischargeable quantity of the negative electrode is not more than 0.5.

<Supplement Charge/Dischargeable Quantity on Side of Positive Electrode With Compound Capable of Performing Doping/Dedoping Reaction in Electrolytic Solution>

In the case of the aforementioned seventeenth of the present invention, for example, the chargeable/dischargeable quantity of the energy storage device can be effectively increased by supplementing the chargeable/dischargeable quantity of the positive electrode contrarily to the case of the aforementioned sixteenth of the present invention, and hence it is important to preferentially increase the quantity of power storage on the side of the positive electrode. Therefore, the electrolytic solution preferably contains a large quantity of (at least 50 mole percent with respect to the overall compound capable of performing a doping/dedoping reaction) of compounds in a state supplementing the quantity of power storage on the side of the positive electrode while not increasing the quantity of power storage on the side of the negative electrode, i.e., a p-doped p-type compound, a dedoped n-type compound, a dedoped pn-type compound and a p-doped pn-type compound.

The eighteenth of the present invention is the energy storage device according to any of the aforementioned first to fifteenth inventions, characterized in that the device satisfies the conditions of the following formula:

−0.2≦(A−B−C+D+E−F)/(A+B+C+D+E+F+G)≦0.2

assuming that

A represents the mole number of a P-doped p-type compound,

B represents the mole number of a dedoped p-type compound,

C represents the mole number of an N-doped n-type compound,

D represents the mole number of a dedoped n-type compound,

E represents the mole number of a P-doped pn-type compound,

F represents the mole number of an N-doped pn-type compound, and

G represents the mole number of a dedoped pn-type compound

as compounds capable of performing a doping/dedoping reaction, when the ratio of the chargeable/dischargeable quantity of the positive electrode/the chargeable/dischargeable quantity of the negative electrode is greater than 0.5 and less than 2.0.

<Increase Chargeable/Dischargeable Quantity of Energy Storage Device With Compound Capable of Performing Doping/Dedoping reaction in Electrolytic Solution>

In the case of the aforementioned eighteenth of the present invention, for example, it is effective to increase both of the chargeable/dischargeable quantities on the side of the positive electrode and on the side of the negative electrode in a well-balanced manner in order to increase the chargeable/dischargeable quantity of the energy storage device with the compound capable of performing a doping/dedoping reaction in the electrolytic solution, depending on each energy storage device. Therefore, it is important that the compounds (i.e., the n-doped n-type compound, the dedoped p-type compound, the dedoped pn-type compound and the n-doped pn-type compound) in the state supplementing the quantity of power storage on the side of the negative electrode while not increasing the quantity of power storage on the side of the positive electrode or the compounds (i.e., the p-doped p-type compound, the dedoped n-type compound, the dedoped pn-type compound and the p-doped pn-type compound) in the state supplementing the quantity of power storage on the side of the positive electrode while not increasing the quantity of power storage on the side of the negative electrode are not one-sidedly largely contained in the electrolytic solution

(in other words, contained in the range satisfying the conditions of the following formula:

−0.2≦(A−B−C+D+E−F)/(A+B+C+D+E+F+G)≦0.2

assuming that

A represents the mole number of the P-doped p-type compound,

B represents the mole number of the dedoped p-type compound,

C represents the mole number of the N-doped n-type compound,

D represents the mole number of the dedoped n-type compound,

E represents the mole number of the P-doped pn-type compound,

F represents the mole number of the N-doped pn-type compound, and

G represents the mole number of the dedoped pn-type compound).

The nineteenth of the present invention is a method of manufacturing an energy storage device including a positive electrode, a negative electrode and an electrolytic solution, having the step of mixing a compound capable of performing a doping/dedoping reaction into the electrolytic solution.

<Step of Mixing Compound Capable of Performing Doping/Dedoping Reaction into Electrolytic Solution>

While a method of synthesizing (polymerizing) the compound in the electrolytic solution or the like is also conceivable as the method of introducing the compound capable of performing a doping/dedoping reaction into the electrolytic solution, the same is sufficiently implemented by simply mixing the compound into the electrolytic solution. The compound (π-conjugate polymer or π-conjugate molecules) capable of performing a doping/dedoping reaction can generally be obtained on the market at a relatively low cost, and the step of mixing the same into the electrolytic solution is extremely simple as a method of manufacturing the electrolytic solution containing the compound capable of performing a doping/dedoping reaction and convenient also in view of the manufacturing cost. The compound mixed into the electrolytic solution may be dissolved into the electrolytic solution.

The twentieth of the present invention is the method of manufacturing an energy storage device according to the aforementioned nineteenth invention, improving the chargeable/dischargeable quantity of the overall energy storage device by selecting the ratio of the compound capable of performing a doping/dedoping reaction in a doped state with respect to the overall compound capable of performing a doping/dedoping reaction and the classification of p-type/n-type/pn-type in response to the ratio between the chargeable/dischargeable quantities of the positive electrode and the negative electrode when mixing the compound capable of performing a doping/dedoping reaction into the electrolytic solution.

The inventors have found that no doping may be performed after mixing the compound with the electrolytic solution but the compound in the doped state may simply be previously mixed into the electrolytic solution when the compound in the doped state is to be present in the electrolytic solution. The inventors have also found that a compound containing a dopant of a type different from that of the dopant contained in the electrolytic solution can be mixed into the electrolytic solution with no problem so far as the compound is in a doped state, unless the dopant previously contained in the compound exerts bad influence on the subsequent doping/dedoping reaction in the electrolytic solution. They have further found that no dedoping treatment may be newly performed after mixing the compound with the electrolytic solution but the compound in a dedoped state may simply be previously mixed into the electrolytic solution when the compound in the dedoped state is to be present in the electrolytic solution. If the type (p-type, n-type or pn-type) and the doped state/dedoped state of the compound to be present in the electrolytic solution is recognized, therefore, the quantity of energy stored in the energy storage device can be easily increased by simply mixing the compound into the electrolytic solution in the desired doped/dedoped state as described with reference to the aforementioned sixteenth to nineteenth inventions, and hence the “method of manufacturing an energy storage device which is the twentieth of the present invention” is extremely useful as a method of manufacturing a high-performance energy storage device. The compound mixed into the electrolytic solution may be dissolved in the electrolytic solution.

Three examples of “improving the chargeable/dischargeable quantity of the overall energy storage device by selecting the ratio of the compound capable of performing a doping/dedoping reaction in the doped state with respect to the overall compound capable of performing a doping/dedoping reaction and the classification of p-type/n-type/pn-type in response to the ratio between the chargeable/dischargeable quantities of the positive electrode and the negative electrode when mixing the compound capable of performing a doping/dedoping reaction into the electrolytic solution” are now described.

### EXAMPLE 7

### Improvement of Chargeable/Dischargeable Quantity of Electric Double Layer Capacitor

The electric double layer capacitor is an energy storage device storing charges in an electric double layer formed on the interface between an electrolytic solution and an electrode. The capacitance of the electric double layer capacitor is proportional to the electrode area, and hence active carbon or the like having a high specific surface area is employed for the electrode. There is no distinction between a positive electrode and a negative electrode, and the capacitance levels of the two electrodes can be regarded as generally identical to each other. While an oxidation reaction takes place in one of the electrodes at the time of charge, the quantity of power storage in the charge resulting from the oxidation reaction can be increased if a p-doping or n-dedoping reaction of the compound in the electrolytic solution takes place in a region of the electrolytic solution around this electrode at this time. A reduction reaction contrarily takes place in the other electrode at the time of charge, and hence the quantity of power storage in the charge resulting from the reduction reaction can be increased if an n-doping or p-dedoping reaction of the compound in the electrolytic solution takes place in a region of the electrolytic solution around this electrode at this time.

Therefore, when mixing a p-type compound in a p-doped state and a p-type compound in a dedoped state into the electrolytic solution in an equimolar manner, for example, the capacitance levels of both electrodes can be substantially equally increased, and the chargeable/dischargeable quantity of the electric double layer capacitor can be effectively increased as a whole, i.e., the energy density can be effectively increased.

This also applies to a case of mixing an n-type compound in an n-doped state and an n-type compound in a dedoped state into the electrolytic solution in an equimolar manner. The p-type or n-type compound mixed in this step may not be of one type, but at least two types of compounds may be mixed into the electrolytic solution at the same time. In a case of two of these, the voltage of charge/discharge by redox of the electrolytic solution is not much high in general. A potential causing either p-doping/p-dedoping or n-doping/n-dedoping does not much vary with the type of the compound in general, and the charge/discharge voltage is up to about 1.5 V if only either the p-type or the n-type is used even when at least two types of compounds are employed.

Also when mixing a p-type compound in a dedoped state and an n-type compound in a dedoped state into the electrolytic solution in an equimolar manner, the chargeable/dischargeable quantity of the electric double layer can be increased as a whole similarly to the above, i.e., the energy density can be effectively increased. In this case, however, the charge/discharge voltage can be increased up to about 3 V, more preferably in view of improving the energy density. The potential causing p-doping/p-dedoping and the potential causing n-doping/n-dedoping are generally different from each other, and a higher charge/discharge voltage is generally obtained when both of the p-type and the n-type are utilized for charge/discharge, as compared with a case of using only one of the p-type and the n-type. The mixed p-type or n-type compound may not be of one type in this case either, but at least two types of compounds may be mixed into the electrolytic solution at the same time. In this case, only one of the p-type and n-type compounds can contribute to charge/discharge around one electrode, and it follows that the other compound does not basically contribute to the charge/discharge.

Further, the energy density of the electric double layer capacitor can be effectively improved also by mixing a pn-type compound in a dedoped state into the electrolytic solution. Also in this case, the charge/discharge voltage can be increased up to about 3 V, preferably in view of improving the energy density. In addition, the compound present around the electrode can entirely contribute to charge/discharge on the side of each electrode, whereby a larger quantity of charges can be more preferably charged/discharged as compared with the aforementioned case even when the compound is mixed in the same quantity. The mixed p-type or n-type compound may not be of one type in this case either, but at least two types of compounds may be mixed into the electrolytic solution at the same time.

### EXAMPLE 8

### Improvement of Chargeable/Dischargeable Quantity of Redox Capacitor

This is an energy storage device storing charges through oxidation-reduction reactions of active materials of electrodes. For example, a conductive polymer redox capacitor employing poly-3-(4-fluorophenyl) thiophene which is a pn-type π-conjugate polymer for both electrodes can be listed. Also in such a conductive polymer redox capacitor, the capacitance levels of the two electrodes can be basically regarded as generally identical to each other. While an oxidation reaction takes place in one of the electrodes at the time of charge, the quantity of power storage in the charge resulting from the oxidation reaction can be increased if a p-doping or n-dedoping reaction of the compound in the electrolytic solution takes place in a region of the electrolytic solution around this electrode at this time. A reduction reaction contrarily takes place in the other electrode at the time of charge, and hence the quantity of power storage in the charge resulting from the reduction reaction can be increased if an n-doping or p-dedoping reaction of the compound in the electrolytic solution takes place in a region of the electrolytic solution around this electrode at this time. The basic idea is identical, and hence the energy density can be improved by a method similar to that in the aforementioned electric double layer capacitor. If the chargeable/dischargeable quantities of the respective electrodes are different from each other, effective energy density improvement of the capacitor can be implemented when selecting the ratio between the doped state and the dedoped state of the compounds mixed into the electrolytic solution and the type (p-type, n-type or pn-type) of the π-conjugate compound so that the redox capacitance of the electrolytic solution remarkably appears on the side of the electrode having the smaller chargeable/dischargeable quantity.

### EXAMPLE 9

### Improvement of Chargeable/Dischargeable Quantity of Lithium Ion Electrolytic Capacitor

A lithium ion electrolytic capacitor employs an electrolytic solution containing lithium ions, the side of a positive electrode stores charges through an electric double layer on the interface between an active carbon electrode and the electrolytic solution, and the side of a negative electrode stores charges through intercalation of lithium ions into graphite. Charge/discharge at a high voltage is possible due to a large potential difference between the positive electrode and the negative electrode. However, the capacitance of the positive electrode is small as compared with the negative electrode, and hence it is desirable if the energy density can be improved by increasing the chargeable/dischargeable quantity on the side of the positive electrode. Therefore, the energy density of the lithium ion electrolytic capacitor can be improved when mixing at least one of a p-type compound in a dedoped state, an n-type compound in a doped state and a pn-type compound in a dedoped state while not mixing a p-type compound in a doped state, an n-type compound in a dedoped state and a pn-type compound in a p-doped state into the electrolytic solution or mixing the same in a smaller quantity as compared with the aforementioned three. The p-type compound in the dedoped state and/or the pn-type compound in the dedoped state is preferably mixed into the electrolytic solution as compared with the n-type compound in the doped state, in view of increasing the discharge voltage.

### EXAMPLES

While the present invention is now more specifically described with reference to Examples, the present invention is not in the least restricted to these Examples but can be properly modified in the range not changing the subject matter thereof.

### Example 1

<Preparation of Electrolytic Solution>

200 g of an ionic liquid 1-ethyl-3-methylimidazolium tosylate vacuum-dried at 90° C. for 10 days was introduced into a flask as a solvent for an electrolytic solution, and stirred with addition of 20 g of polyaniline (Aldrich, Mw=5000). The mixture was stirred and gradually heated up to 190° C. for dissolving the overall polyaniline, thereafter left/cooled at ordinary temperature, and filtrated to confirm that there was no insoluble.

<Cyclic Voltammogram Measurement>

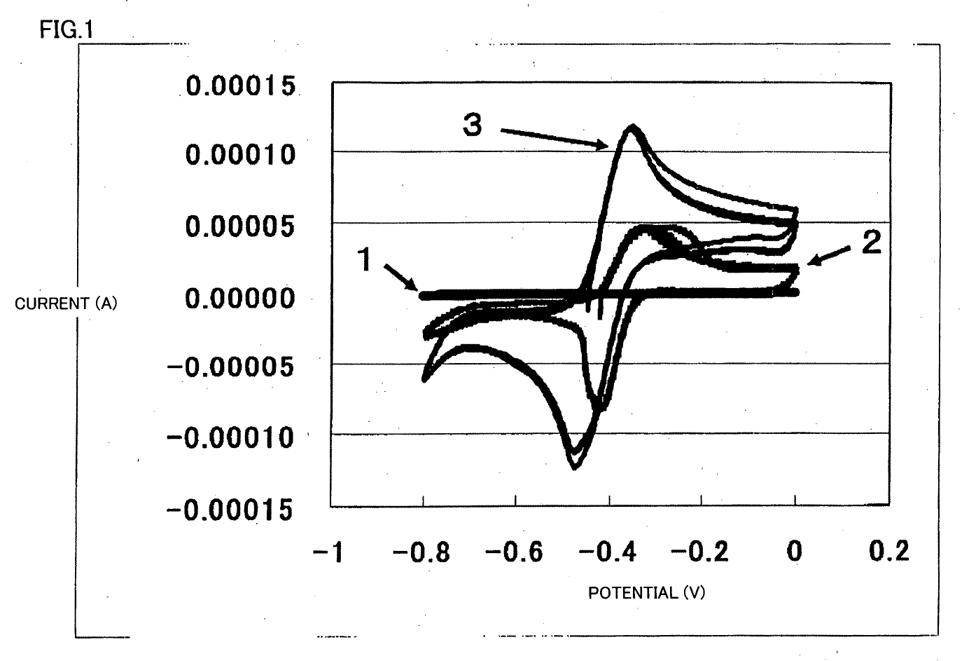

The obtained electrolytic solution was introduced into a small-sized beaker, and cyclic voltammogram (CV) measurement was performed in a glove box while employing platinum plates for a working electrode and a counter electrode and an Ag/Ag+ electrode for a reference electrode. FIG. 1 (number 3) shows a result obtained by performing an operation of changing the voltage from 0 V up to −0.8 V at a sweep rate of 5 mV/sec. and thereafter returning the same to 0 V at the same rate continuously five times.

<Charge/Discharge Measurement>

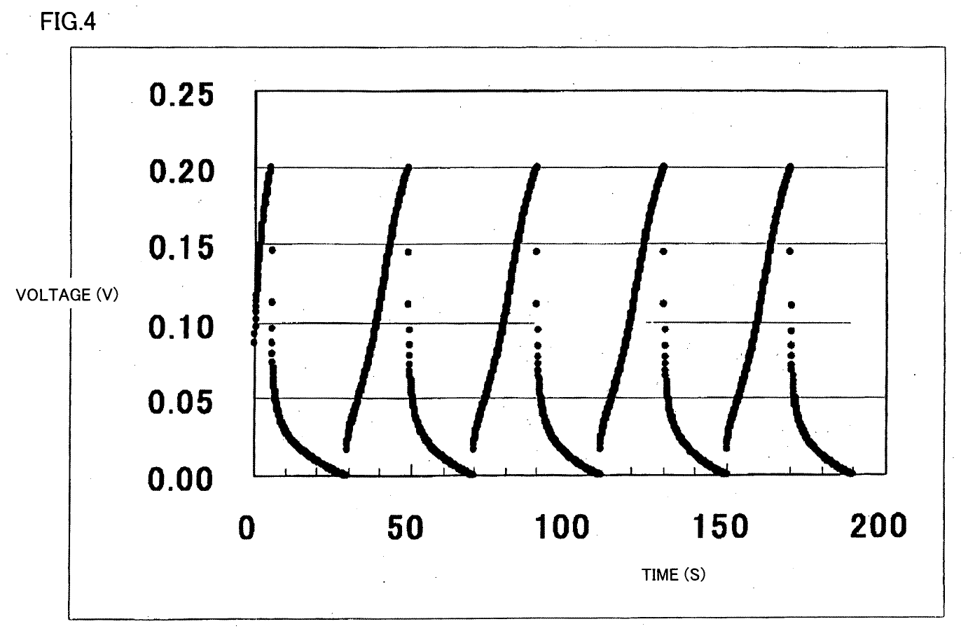

Two platinum electrodes were inserted into the same small-sized beaker, and a charge/discharge test was conducted with a bipolar cell. The interelectrode distance was 1 cm, and the electrode areas in the solution were 1 cm². Charge was performed from 0 V up to an upper limit of 0.2 V at a charging speed of 0.05 mA/sec., and discharge was performed to reach 0 V at the same discharging speed when reaching 0.2 V. An operation of starting charge again in the instant of completion of discharge was repetitively performed five times in total. The voltage change at this time was measured, and FIG. 4 shows the result.

### Example 2

<Preparation of Electrolytic Solution>

An electrolytic solution was prepared by a method similar to that in Example 1 except that the quantity of polyaniline (Aldrich, Mw=5000) dissolved with respect to 200 g of an ionic liquid 1-ethyl-3-methylimidazolium tosylate which is a solvent for the electrolytic solution was set to 2 g.

<Cyclic Voltammogram Measurement>

CV measurement was performed by a method absolutely identical to that in Example 1 except that the sample obtained in the aforementioned item of preparation of the electrolytic solution was employed as the electrolytic solution. FIG. 1 (number 2) shows the result.

<Charge/Discharge Measurement>

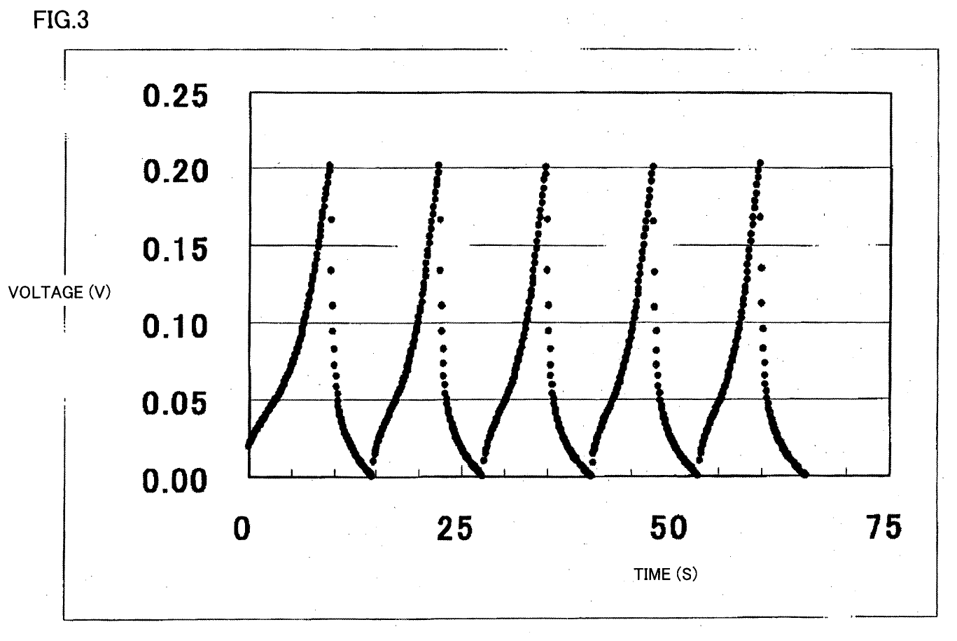

Charge/discharge measurement was performed by a method absolutely identical to that in Example 1 except that the sample obtained in the aforementioned item of preparation of the electrolytic solution was employed as the electrolytic solution. FIG. 3 shows the result.

### Comparative Example 1

<Preparation of Electrolytic Solution>

An ionic liquid 1-ethyl-3-methylimidazolium tosylate vacuum-dried at 90° C. for 10 days with no additive was prepared as an electrolyte.

<Cyclic Voltammogram Measurement>

CV measurement was performed by a method absolutely identical to that in Example 1 except that the aforementioned additive-free ionic liquid 1-ethyl-3-methylimidazolium tosylate was employed as the electrolytic solution. FIG. 1 (number 1) shows the result.

<Charge/Discharge Measurement>

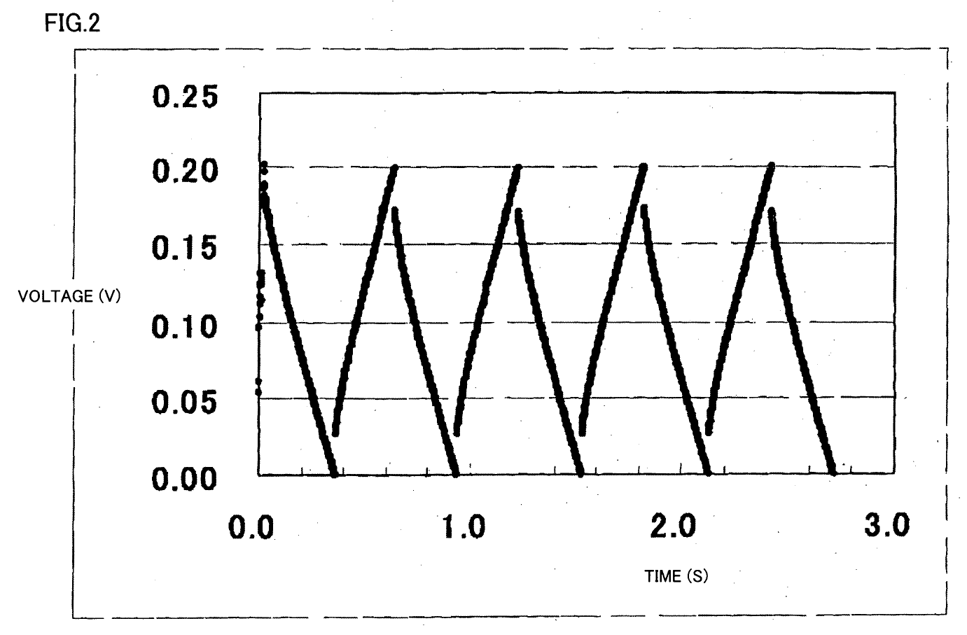

Charge/discharge measurement was performed by a method absolutely identical to that in Example 1 except that the aforementioned additive-free ionic liquid 1-ethyl-3-methylimidazolium tosylate was employed as the electrolytic solution. FIG. 2 shows the result.

<Consideration of Results>

In the cyclic voltammogram shown in FIG. 1, the current signal is not more than 1 μA with potential sweep in the range of −0.8 V to 0.0 V in the sole ionic liquid electrolytic solution (number 1) of 1-ethyl-3-methylimidazolium tosylate. The currents attending the electric double layer capacitance of the platinum electrodes expectable for observation were not observable due to excessively small surface areas.

In the electrolytic solution (number 2) prepared by dissolving 1 part by weight of polyaniline in 100 parts by weight of 1-ethyl-3-methylimidazolium tosylate, on the other hand, a current signal of about 0.05 mA to 0.08 mA regarded as attending a redox reaction of the electrolytic solution was observed in the same potential sweep range. The positive signal around −0.3 to −0.4 V and the negative signal around −0.5 to −0.4 V are conceivably currents attending doping with paratoluene sulfonate anions and dedoping respectively.

In the electrolytic solution (number 3) prepared by dissolving 10 parts by weight of polyaniline in 100 parts by weight of 1-ethyl-3-methylimidazolium tosylate, a current signal exceeding 0.1 mA regarded as attending a redox reaction of the electrolytic solution was observed in the same potential sweep range. The respective peak positions are substantially identical to those of the electrolytic solution of the number 2. This indicates that the signal increases as the concentration is increased, although the same is not completely proportional to the concentration.

FIGS. 2 to 4 show results obtained by actually preparing bipolar cells and executing a charge/discharge test. A potential difference is caused between electrodes when a constant current is continuously fed. In the sole ionic liquid electrolytic solution (FIG. 2) of 1-ethyl-3-methylimidazolium tosylate, the voltage reached 0.2 V and the charge was terminated in about only 0.5 seconds. In the electrolytic solution (FIG. 3) and the electrolytic solution (FIG. 4) prepared by dissolving 1 part by weight and 10 parts by weight of polyaniline in 100 parts by weight of 1-ethyl-3-methylimidazolium tosylate respectively, on the other hand, the charge/discharge times increased to 12 seconds and 40 seconds respectively, and this indicates that charge/discharge attending doping/dedoping of π-conjugate polymers took place.

### Example 3

<Preparation of Electrolytic Solution>

1 g of pyrene indicated in the following formula (1) was dissolved in 30 cc of a solution of propylene carbonate (moisture content: not more than 6 ppm) of 1 mol/liter of tetraethylammonium tetrafluoroborate (moisture content: 4 ppm) in a glove box at room temperature:

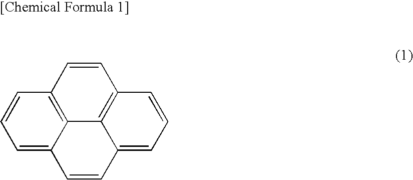

<Cyclic Voltammogram Measurement>

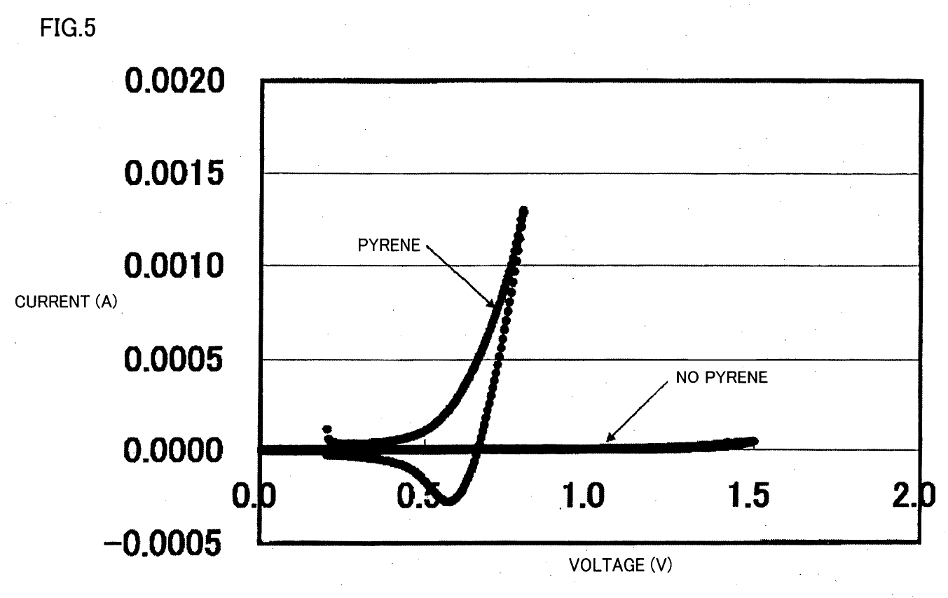

The obtained electrolytic solution was introduced into a small-sized beaker, and cyclic voltammogram (CV) measurement was performed in a glove box while employing platinum plates for a working electrode and a counter electrode and an Ag/Ag+ electrode for a reference electrode. The voltage was changed from +0.2 V up to +0.8 V at a sweep rate of 5 mV/sec. and thereafter returned to 0.2 V at the same rate, for reading the current value. As a spectrum containing no π-conjugate molecules, CV measurement was performed by employing 30 cc of a propylene carbonate solution of 1 mol/liter of tetraethylammonium tetrafluoroborate containing no pyrene with the same working electrode, the same counter electrode and the same reference electrode. FIG. 5 shows the result. FIG. 5 shows another result obtained by changing the voltage in the range of 0.0 V to 1.5 V at a similar sweep rate by way of precaution.

<Charge/Discharge Measurement>

Two platinum electrodes were inserted into the same small-sized beaker, and a charge/discharge test was conducted with a bipolar cell. The interelectrode distance was 1 cm, and the electrode areas in the solution were 1 cm². Charge was performed from 0 V up to an upper limit of 1.5 V at a charging speed of 0.05 mA/sec., and discharge was performed to reach 0 V at the same discharging speed when reaching 1.5 V. Such a tendency that the charge/discharge quantity increased by repetition was recognized in this test, and hence the test was repetitively conducted by 500 cycles.

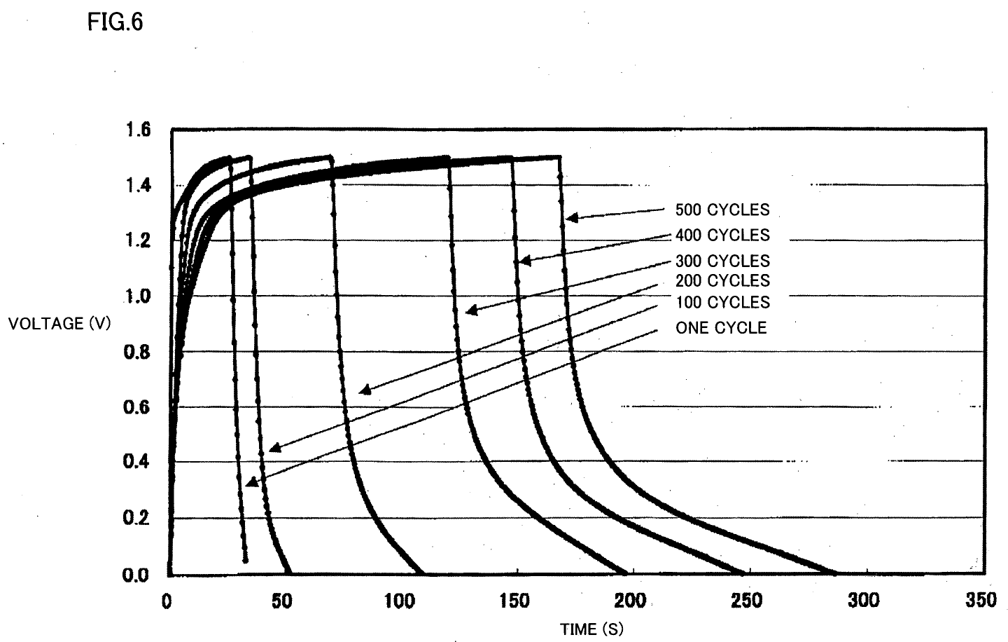

FIG. 6 shows the results of the first cycle, the 100^{th} cycle, the 200^{th} cycle, the 300^{th} cycle, the 400^{th} cycle and the 500^{th} cycle.

### Example 4

<Preparation of Electrolytic Solution>

3.75 g of coronene indicated in the following formula (2) was added to 30 cc of a solution of chloroform (moisture content: not more than 6 ppm) of 0.2 mol/liter of tetraethylammonium tetrafluoroborate (moisture content: 4 ppm) in a glove box at room temperature:

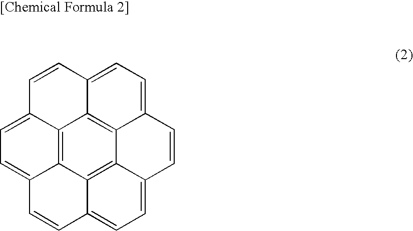

<Cyclic Voltammogram Measurement>

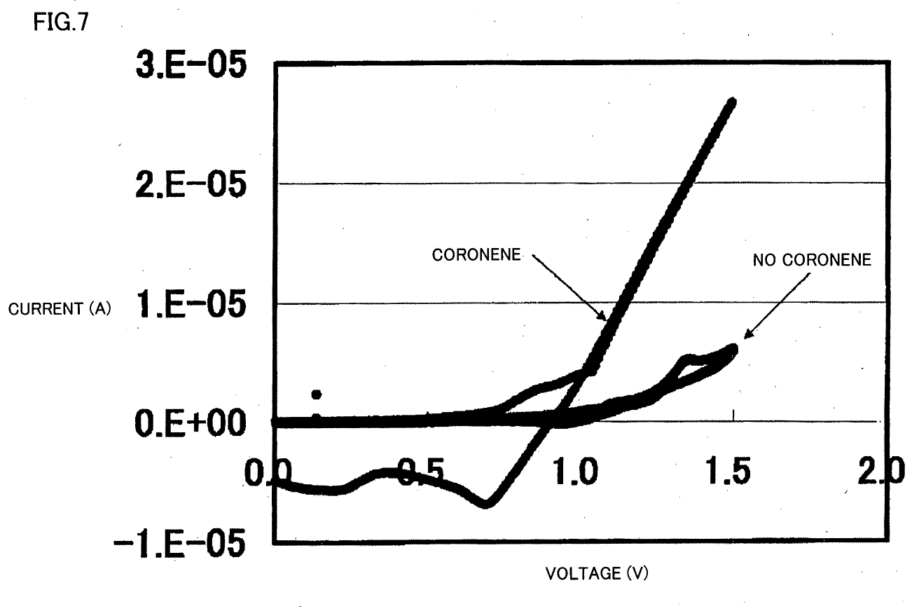

CV measurement was performed by a method absolutely identical to that in Example 3 except that the sample obtained in the aforementioned item of preparation of the electrolytic solution was employed as the electrolytic solution. However, the voltage sweep range was set to 0.0V to 1.5 V. FIG. 7 also shows a result obtained by performing similar measurement except that coronene was not dissolved.

### Comparative Example 2

<Preparation of Electrolytic Solution>

15 cc of iodobenzene indicated in the following formula (3) was dissolved in 30 cc of a solution of propylene carbonate (moisture content: not more than 6 ppm) of 1 mol/liter of tetraethylammonium tetrafluoroborate (moisture content: 4 ppm) in a glove box at room temperature:

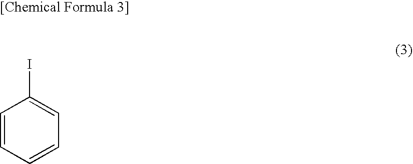

<Cyclic Voltammogram Measurement>

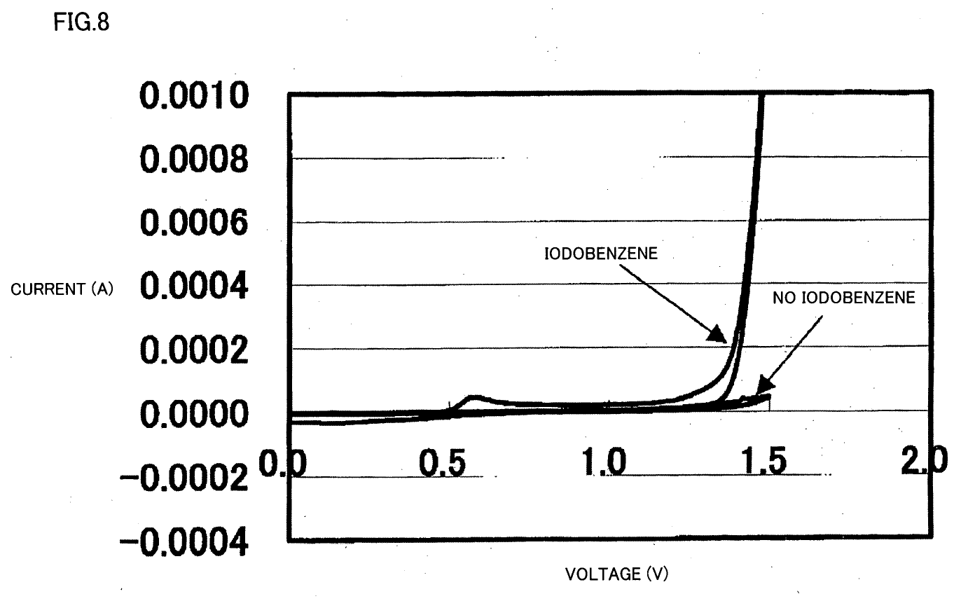

CV measurement was performed by a method absolutely identical to that in Example 4 except that the aforementioned propylene carbonate of tetraethylammonium tetrafluoroborate to which iodobenzene was added was employed as the electrolytic solution. FIG. 8 shows the result along with a result in a case of adding no iodobenzene.

### Comparative Example 3

<Preparation of Electrolytic Solution>

1 g of benzimidazole indicated in the following formula (4) was dissolved in 30 cc of a solution of propylene carbonate (moisture content: not more than 6 ppm) of 1 mol/liter of tetraethylammonium tetrafluoroborate (moisture content: 4 ppm) in a glove box at room temperature:

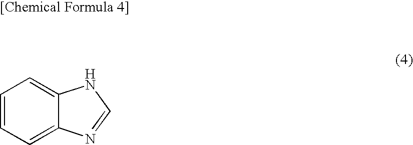

<Cyclic Voltammogram Measurement>

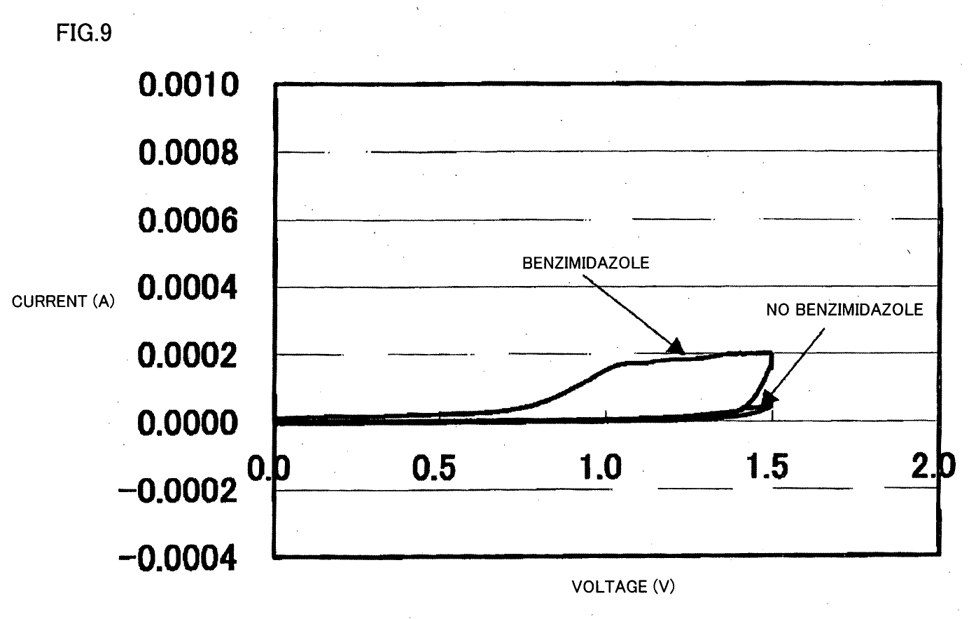

CV measurement was performed by a method absolutely identical to that in Example 4 except that the aforementioned propylene carbonate of tetraethylammonium tetrafluoroborate to which benzimidazole was added was employed as the electrolytic solution. FIG. 9 shows the result along with a result in a case of adding no benzimidazole.

### Comparative Example 4

<Preparation of Electrolytic Solution>

15 cc of quinoline indicated in the following formula (5) was dissolved in 30 cc of a solution of propylene carbonate (moisture content: not more than 6 ppm) of 1 mol/liter of tetraethylammonium tetrafluoroborate (moisture content: 4 ppm) in a glove box at room temperature:

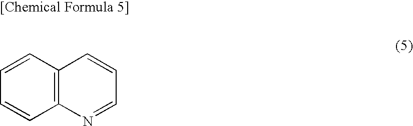

<Cyclic Voltammogram Measurement>

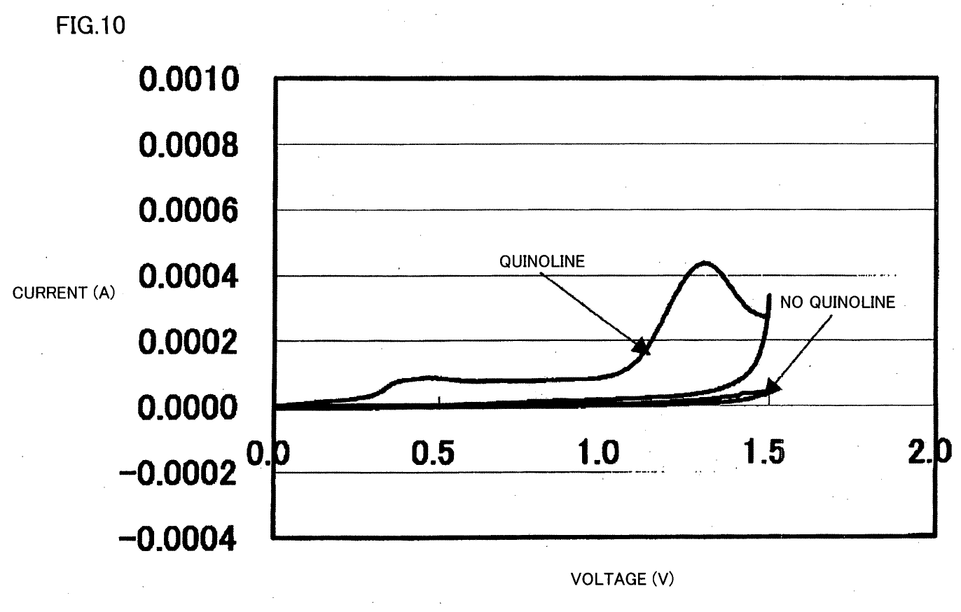

CV measurement was performed by a method absolutely identical to that in Example 4 except that the aforementioned propylene carbonate of tetraethylammonium tetrafluoroborate to which quinoline was added was employed as the electrolytic solution. FIG. 10 shows the result along with a result in a case of adding no quinoline.

<Consideration of Results>

In the case of employing the electrolytic solution prepared by dissolving pyrene is employed in the cyclic voltammogram shown in FIG. 5, a positive-directional current is observed when the voltage is increased from 0.3 V up to 0.7 V. This is a current by far larger than the current observed in the spectrum of the electrolytic solution prepared by not dissolving pyrene, and it is predicted that this is a current relevant to pyrene. When the voltage is continuously lowered from 0.7 V to 0.3 V, the positive-directional current changes to a negative-directional current, and stored charges are released.

A substantially reversible spectrum is continuously observed also when this voltage increase-voltage decrease cycle is repeated, and hence it is possible to store energy through this current change.

FIG. 6 shows the results of the charge/discharge test of the bipolar cell employing the two platinum electrodes. It is interesting that the cell exhibits a certain extent of charge/discharge characteristic from the first cycle while the quantity of storable charges gradually increases as the charge/discharge cycle is repeated. This charge/discharge is performed at a constant current, and hence the increase of the discharge time indicates that the quantity of storable charges has increased.

While the detailed cause is ambiguous, the concentration distribution of pyrene molecules in the electrolytic solution conceivably changed to be capable of easily storing charges due to the repeated charge/discharge.

The electrolytic solution substantially returns to the state of the first cycle when stirred after the charge/discharge is repeated to some extent. This indicates that it is an effective means to suppress energy release resulting from dispersion of the electrolytic solution or the like, in order to apply the electrolytic solution to an energy device for storing charges.

These π-conjugate molecules having a relatively small molecular weight have a wider alternative range as to solvents than the π-conjugate polymer, are capable of forming a solution of high concentration, have a possibility of penetrating into micropores of active carbon, and are effective for forming an energy device.

FIG. 7 shows the result of the CV measurement of the electrolytic solution employing coronene having a carbon number of 24 in place of pyrene having a carbon number of 16. The solvent for the electrolytic solution was prepared from trichloromethane, and the voltage sweep range was set to 0.0 V to 1.5 V. A large current flows in the positive direction in the electrolytic solution containing coronene, as compared with the spectrum of the electrolytic solution with the solvent of trichloromethane containing no coronene. No opposite current flows in the case of the electrolytic solution containing no coronene even if the voltage is lowered, and hence the current in voltage increase is conceivably a current attending an irreversible change resulting from decomposition of the electrolytic solution or the like.

In the electrolytic solution containing coronene, on the other hand, an opposite current enabling energy storage is observed in voltage reduction, similarly to the case of pyrene. This flow of the current remains unchanged also when the charge/discharge is repeated a plurality of times, and hence application to an energy device is conceivably possible.

FIGS. 8, 9 and 10 show the results of the CV measurement of iodobenzene, benzimidazole and quinoline containing 6, 7 and 9 carbon atoms, namely, containing not more than 14 carbon atoms, in a single molecule respectively. In each case, no opposite current in voltage reduction was observed although a current larger than that in the spectrum of the electrolytic solution containing no π-conjugate molecules was observed in voltage increase. Therefore, energy cannot be stored with the electrolytic solution containing these π-conjugate molecules.

### Example 5

An experiment was entirely performed in a glove box replaced with high-purity argon for eliminating influence by moisture in the atmosphere.

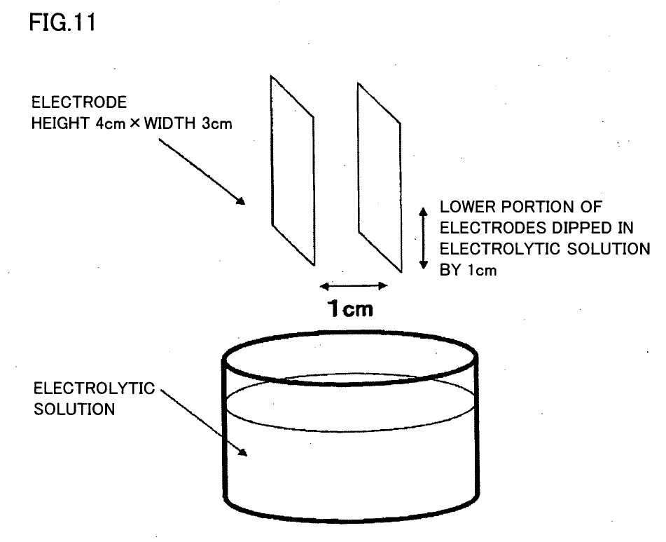

1.5 g of polyaniline (emeraldine doped with organic sulfonic acid, number average molecular weight: at least 15000, by Aldrich) in a doped state and 1.5 g of polyaniline (emeraldine, weight average molecular weight: at least 5000, by Aldrich) in a dedoped state were added to 27 g (about 18 ml) of an ionic liquid 1-ethyl-3-methylimidazolium tosylate and stirred for 20 minutes, for preparing an electrolytic solution for charge/discharge measurement. This electrolytic solution was introduced into a beaker, and a pair of graphite sheet electrodes of 4 by 3 cm were opposed to each other at an interval of 1 cm and dipped in the electrolytic solution by 1 cm, for preparing a charge/discharge measurement cell (FIG. 11). Charge/discharge was repeated by five cycles at a constant current of 0.05 mA with a voltage in the range of 0 to 1 V between the two graphite sheets.

### Comparative Example 5

An experiment was entirely performed in a glove box replaced with high-purity argon for eliminating influence by moisture in the atmosphere.

An ionic liquid 1-ethyl-3-methylimidazolium tosylate was introduced into a beaker as an electrolytic solution, and a pair of graphite sheet electrodes of 4 by 3 cm were opposed to each other at an interval of 1 cm and dipped in the electrolytic solution by 1 cm, for preparing a charge/discharge measurement cell (FIG. 11).

Charge/discharge was repeated by five cycles at a constant current of 0.05 mA with a voltage in the range of 0 to 1 V between the two graphite sheets.

### Example 6

An experiment was entirely performed in a glove box replaced with high-purity argon for eliminating influence by moisture in the atmosphere.

3.0 g of polyaniline (emeraldine doped with organic sulfonic acid, number average molecular weight: at least 15000, by Aldrich) in a dedoped state was added to 27 g (about 18 ml) of an ionic liquid 1-ethyl-3-methylimidazolium tosylate and stirred for 20 minutes, for preparing an electrolytic solution for charge/discharge measurement. This electrolytic solution was introduced into a beaker, and a pair of graphite sheet electrodes of 4 by 3 cm were opposed to each other at an interval of 1 cm and dipped in the electrolytic solution by 1 cm, for preparing a charge/discharge measurement cell (FIG. 11). Charge/discharge was repeated by five cycles at a constant current of 0.05 mA with a voltage in the range of 0 to 1 V between the two graphite sheets.

### Example 7

An experiment was entirely performed in a glove box replaced with high-purity argon for eliminating influence by moisture in the atmosphere.

3.0 g of polyaniline (emeraldine, weight average molecular weight: at least 5000, by Aldrich) in a doped state was added to 27 g (about 18 ml) of an ionic liquid 1-ethyl-3-methylimidazolium tosylate and stirred for 20 minutes, for preparing an electrolytic solution for charge/discharge measurement. This electrolytic solution was introduced into a beaker, and a pair of graphite sheet electrodes of 4 by 3 cm were opposed to each other at an interval of 1 cm and dipped in the electrolytic solution by 1 cm, for preparing a charge/discharge measurement cell (FIG. 11). Charge/discharge was repeated by five cycles at a constant current of 0.05 mA with a voltage in the range of 0 to 1 V between the two graphite sheets.

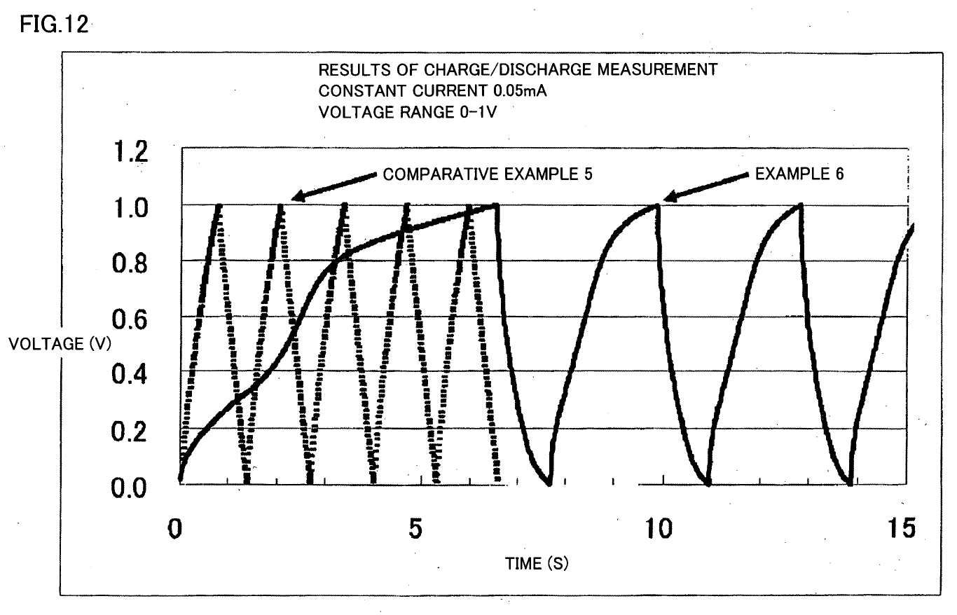

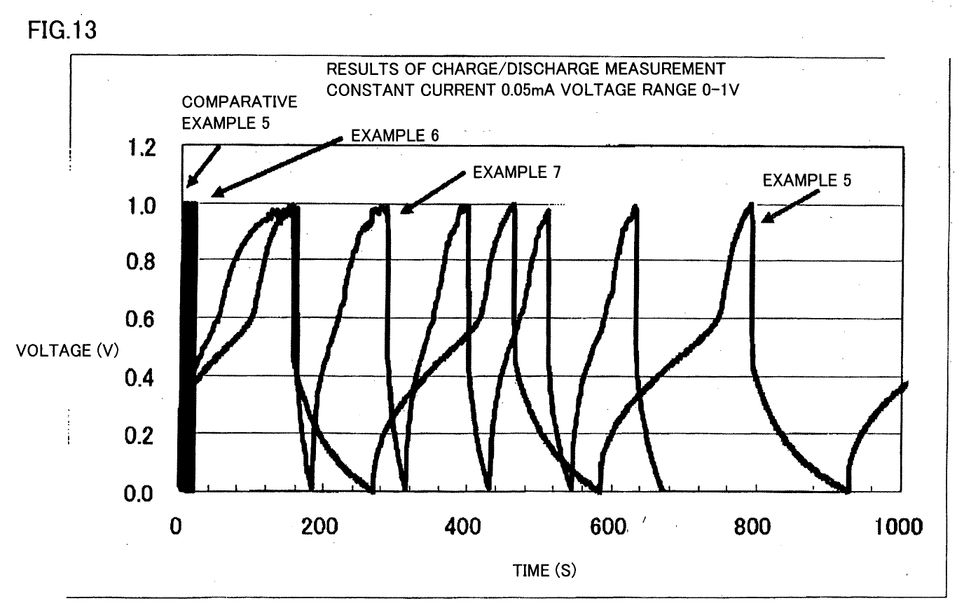

FIGS. 12 and 13 show the results of the charge/discharge measurement performed in Examples 5 to 7 and comparative example 5. From FIG. 12, a linear charge/discharge curve resulting from electric double layer capacitance is obtained, the charge/discharge time is short, and the chargeable/dischargeable quantity is small when employing only the ionic liquid 1-ethyl-3-methylimidazolium tosylate for the electrolytic solution (comparative example 5). As compared with this, there is increase (trailing curve of the graph observed around 0 V at the time of discharge) of the chargeable/dischargeable quantity conceivably resulting from redox of polyaniline in the case of adding 10 wt. % of polyaniline in the dedoped state to the electrolytic solution (Example 6). In a case of essentially adding only polyaniline in a completely dedoped state, the charge/discharge quantity increases only on the side of the positive electrode, and hence the chargeable/dischargeable quantity of the overall cell must remain unchanged. As the reason for this, it is conceivably so difficult to completely bring a conductive polymer into a dedoped state that a small quantity of dopant remains also in the dedoped conductive polymer. Therefore, it is conceivable that the charge/discharge quantity on the side of the negative electrode also increases, and the chargeable/dischargeable quantity of the overall cell also increases. In the case of adding 10 wt % of polyaniline in the doped state to the electrolytic solution (Example 7), the electrostatic capacitance by far largely increases as compared with the case of adding 10 wt % of polyaniline in the dedoped state (Example 6). The electrostatic capacitance further increases in the case of adding 5 wt % of polyaniline in the doped state and 5 wt % of polyaniline in the dedoped state (Example 5). In the graph of this Example 5, a shape conceivably regarded as the increase (capacitance remarkably increased in the voltage range of not more than 0.5 V in both of charge and discharge) of the electrostatic capacitance resulting from redox of polyaniline clearly appears. When polyaniline is doped around one electrode, for example, polyaniline must be dedoped around the other electrode in view of charge balance, and hence it is theoretically most preferable to add polyaniline in the doped state and polyaniline in the dedoped state to the electrolytic solution in the molar ratio of 1:1 as in the graph of Example 5, in order to effectively develop the capacitance. While large increase of the electrostatic capacitance is observed also in the case of adding 10 wt % of polyaniline in the doped state (Example 7), this is conceivably because the used commercially available polyaniline in the doped state is not in a completely saturated doped state but partially includes a dedoped portion. Thus, remarkable increase of the capacitance can be easily implemented by simply varying the ratio of the compound in the doped state and that in the dedoped state added to the electrolytic solution, and this can be widely applied to a general energy storage device having an electrolytic solution.

### Example 8

An experiment was entirely performed in a glove box replaced with high-purity argon for eliminating influence by moisture in the atmosphere.

3.0 g of polyaniline (emeraldine doped with organic sulfonic acid, number average molecular weight: at least 15000, by Aldrich) in a doped state and 3.0 g of polyaniline (emeraldine, weight average molecular weight: at least 5000, by Aldrich) in a dedoped state were added to 27 g (about 18 ml) of an ionic liquid 1-ethyl-3-methylimidazolium tosylate and stirred for 20 minutes, for preparing an electrolytic solution for charge/discharge measurement. This electrolytic solution was introduced into a beaker, and a pair of platinum plate electrodes of 4 by 3 cm were opposed to each other at an interval of 1 cm and dipped in the electrolytic solution by 1 cm, for preparing a charge/discharge measurement cell (FIG. 11). Charge/discharge was repeated by five cycles at a constant current of 0.05 mA with a voltage in the range of 0 to 1 V between the two platinum plates.

### Example 9

An experiment was entirely performed in a glove box replaced with high-purity argon for eliminating, influence by moisture in the atmosphere.

1.5 g of polyaniline (emeraldine doped with organic sulfonic acid, number average molecular weight: at least 15000, by Aldrich) in a doped state and 1.5 g of polyaniline (emeraldine, weight average molecular weight: at least 5000, by Aldrich) in a dedoped state were added to 27 g of a propylene carbonate solution (1 M, by Sanwa Yuka Kogyo Co., Ltd.) of tetraethylammonium tetrafluoroborate and stirred for 20 minutes, for preparing an electrolytic solution for charge/discharge measurement. This electrolytic solution was introduced into a beaker, and a pair of platinum plate electrodes of 4 by 3 cm were opposed to each other at an interval of 1 cm and dipped in the electrolytic solution by 1 cm, for preparing a charge/discharge measurement cell (FIG. 11). Charge/discharge was repeated by five cycles at a constant current of 0.05 mA with a voltage in the range of 0 to 1 V between the two platinum plates.

### Comparative Example 6

An experiment was entirely performed in a glove box replaced with high-purity argon for eliminating influence by moisture in the atmosphere.

A propylene carbonate solution (1 M, by Sanwa Yuka Kogyo Co., Ltd.) of tetraethylammonium tetrafluoroborate was introduced into a beaker as an electrolytic solution, and a pair of platinum plate electrodes of 4 by 3 cm were opposed to each other at an interval of 1 cm and dipped in the electrolytic solution by 1 cm, for preparing a charge/discharge measurement cell (FIG. 11). Charge/discharge was repeated by five cycles at a constant current of 0.05 mA with a voltage in the range of 0 to 1 V between the two platinum plates.

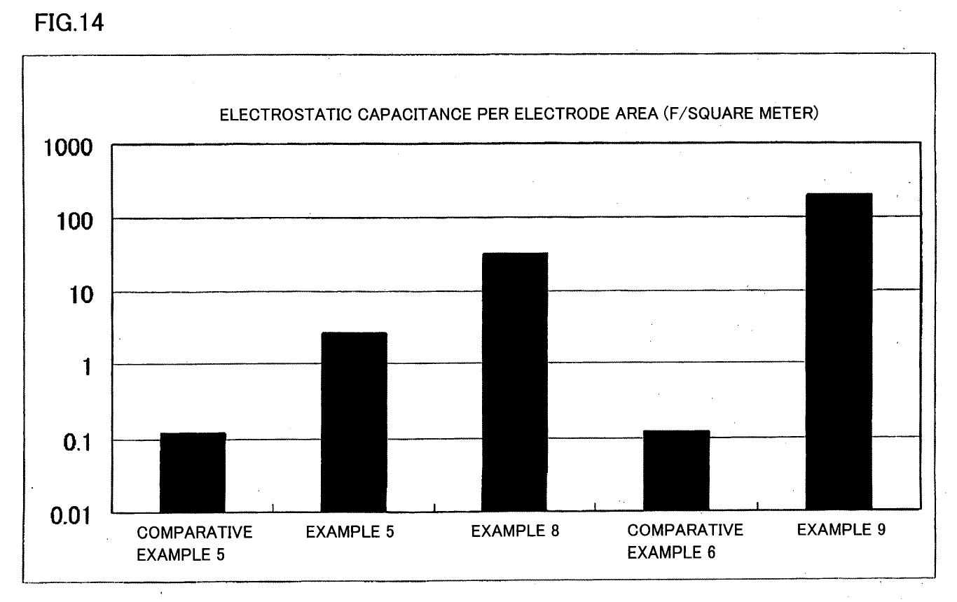

FIG. 14 shows the electrostatic capacitance (F/m²) per electrode surface area (surface area of one electrode) in each of Examples 5, 8 and 9 and comparative examples 5 and 6. The value of the electrostatic capacitance (F) was obtained by dividing the discharge quantity (C) in the fifth cycle of a charge/discharge curve with a constant current as shown in FIG. 12 or 13 by the discharge voltage (1 V in the case of FIG. 12 or 13). When the chargeable/dischargeable quantities of both electrodes are substantially equal to each other, it is understood that the chargeable/dischargeable quantity (energy density) of the overall cell can be improved by adding p-type π-conjugate compounds in a dedoped state and a doped state to the electrolytic solution at a substantially equal molar ratio, for example. It is also understood that the quantity of the π-conjugate compounds added to the electrolytic solution is desirably larger in view of improvement of the chargeable/dischargeable quantity (energy density).

### Example 10

An experiment was entirely performed in a glove box replaced with high-purity argon for eliminating influence by moisture in the atmosphere.

<Preparation of Electrolytic Solution>

1.5 g of polyaniline (emeraldine doped with organic sulfonic acid, number average molecular weight: at least 15000, by Aldrich) in a doped state and 1.5 g of polyaniline (emeraldine, weight average molecular weight: at least 5000, by Aldrich) in a dedoped state were added to 27 g (about 18 ml) of an ionic liquid 1-ethyl-3-methylimidazolium tosylate and stirred for 20 minutes, for preparing an electrolytic solution for a capacitor model cell.

<Preparation of Electrode>

Paste (graphite powder: 80 wt %, polyvinylidene fluoride: 10%, conductive assistant (carbon black, VULCAN XC72R by CABOT)) containing graphite powder (MCMB25-28 by Osaka Gas Chemicals Co., Ltd.) was applied onto a single surface of electrolytic copper foil, dried at 100° C. for 30 minutes, thereafter further dried at 120° C. for 2 hours and punched into circular shapes with a punch of 13 mm in diameter, so that these were employed as electrodes of the capacitor model cell.

<Preparation of Capacitor Model Cell>

An HS cell produced by Hosen Corporation, the electrodes (punched into the circular shapes with the punch of 13 mm in diameter) prepared in the above and a separator of an insulating nonwoven fabric (cut into a thickness of about 90 μm and a diameter of about 20 mm) were vacuum-dried at 120° C. for 2 hours. Then, the two electrodes and the separator dried in the above were vacuum-impregnated with the electrolytic solution prepared in the above for 10 minutes at ordinary temperature. The impregnated electrodes were introduced into the HS cell to hold the impregnated separator therebetween while opposing the surfaces coated with the graphite powder, and 0.2 ml of the electrolytic solution prepared in the above was further introduced into the HS cell, which in turn was covered with the lid for forming a model cell for the capacitor.

<Charge/Discharge Measurement>

The model cell of the capacitor prepared in the above was charged/discharged with a constant current of 1 mA. The voltage for the charge/discharge was set to 0 to 1 V, and the charge/discharge was performed by 5 cycles. The electrostatic capacitance was evaluated from the discharge at the fifth cycle. The electrostatic capacitance (F/m²) per electrode surface area (surface area of one electrode) obtained similarly to Examples 5, 8 and 9 and comparative examples 5 and 6 was 0.232 F/m².

### Comparative Example 7

An experiment similar to that for Example 10 was performed except that only an ionic liquid 1-ethyl-3-methylimidazolium tosylate was used as an electrolytic solution for a capacitor model cell. The electrostatic capacitance (F/m²) per electrode surface area (surface area of one electrode) obtained similarly to Examples 5, 8 and 9 and comparative examples 5 and 6 was 0.052 F/m².

It is understood from comparison between Example 10 and comparative example 7 that it is extremely effective to add p-type π-conjugate compounds in doped and dedoped states to an electrolytic solution for a capacitor having two electrodes exhibiting substantially equal chargeable/dischargeable quantities in a substantially equimolar manner for the purpose of improving the electrostatic capacitance (chargeable/dischargeable quantity, energy density) of the capacitor.

1. An energy storage device including a positive electrode, a negative electrode and an electrolytic solution, wherein
a compound capable of performing a doping/dedoping reaction is present in said electrolytic solution.

2. The energy storage device according to claim 1, wherein
the concentration of said compound capable of performing a doping/dedoping reaction with respect to said electrolytic solution is at least 5 percent by weight and not more than 95 percent by weight.

3. The energy storage device according to claim 1, wherein
said compound capable of performing a doping/dedoping reaction is at least partially dissolved in the electrolytic solution.

4. The energy storage device according to claim 1, wherein
said electrolytic solution is a liquid at least including an ionic liquid.

5. The energy storage device according to claim 4, wherein
said electrolytic solution is a liquid further containing at least one solvent selected from the group consisting of acetonitrile, propylene carbonate, ethylene carbonate and γ-butyrolactone.

6. The energy storage device according to claim 1, wherein
said compound capable of performing a doping/dedoping reaction is a π-conjugate compound.

7. The energy storage device according to claim 1, wherein
said compound capable of performing a doping/dedoping reaction is a π-conjugate polymer.

8. The energy storage device according to claim 1, wherein
said compound capable of performing a doping/dedoping reaction is a π-conjugate compound having a number of carbon atoms of at least 14 and not more than 50.

9. The energy storage device according to claim 8, wherein
said compound capable of performing a doping/dedoping reaction is at least one compound selected from the group consisting of pyrene, naphthacene, chrysene, perylene, benzopyrene, coronene, helicene, pentacene and sexiphenyl and derivatives thereof.

10. The energy storage device according to claim 1, wherein
said positive electrode and said negative electrode are opposed to each other, said electrolytic solution is present between the positive electrode and the negative electrode, and an electrolytic solution free diffusion suppressing means suppressing free diffusion of said compound capable of performing a doping/dedoping reaction is present in the electrolytic solution between the positive electrode and the negative electrode.

11. The energy storage device according to claim 10, wherein
said electrolytic solution free diffusion suppressing means is a separator and/or an electrolytic membrane.

12. The energy storage device according to claim 1, wherein
the compound capable of performing a doping/dedoping reaction present in the electrolytic solution has a first energy storage means storing energy by performing a doping/dedoping reaction.

13. The energy storage device according to claim 12, further having second energy storage means storing energy through electric double layer capacitance on the interfaces between the electrolytic solution and the electrodes.

14. The energy storage device according to claim 12, further having a third energy storage means storing energy through redox reactions of the electrodes.

15. The energy storage device according to claim 12, further containing lithium ions in said electrolytic solution, and having a fourth energy storage means storing energy through intercalation of the lithium ions into a carbon material forming the negative electrode.

16. The energy storage device according to claim 1, containing at least 50 mole percent in total of an N-doped n-type compound, a dedoped p-type compound, a dedoped pn-type compound and an N-doped pn-type compound with respect to the overall compound capable of performing a doping/dedoping reaction as compounds capable of performing a doping/dedoping reaction,
when the ratio of the chargeable/dischargeable quantity of the positive electrode/the chargeable/dischargeable quantity of the negative electrode is at least 2.0.

17. The energy storage device according to claim 1, containing at least 50 mole percent in total of a P-doped p-type compound, a dedoped compound, a dedoped pn-type compound and a P-doped pn-type compound with respect to the overall compound capable of performing a doping/dedoping reaction as compounds capable of performing a doping/dedoping reaction,
when the ratio of the chargeable/dischargeable quantity of the positive electrode/the chargeable/dischargeable quantity of the negative electrode is not more than 0.5.

18. The energy storage device according to claim 1, satisfying the conditions of the following formula:
−0.2≦(A−B−C+D+E−F)/(A+B+C+D+E+F+G)≦0.2
assuming that
A represents the mole number of a P-doped p-type compound,
B represents the mole number of a dedoped p-type compound,
C represents the mole number of an N-doped n-type compound,
D represents the mole number of a dedoped n-type compound,
E represents the mole number of a P-doped pn-type compound,
F represents the mole number of an N-doped pn-type compound, and
G represents the mole number of a dedoped pn-type compound
as compounds capable of performing a doping/dedoping reaction
when the ratio of the chargeable/dischargeable quantity of the positive electrode/the chargeable/dischargeable quantity of the negative electrode is greater than 0.5 and less than 2.0.

19. A method of manufacturing an energy storage device including a positive electrode, a negative electrode and an electrolytic solution,
having the step of mixing a compound capable of performing a doping/dedoping reaction into said electrolytic solution.

20. The method of manufacturing an energy storage device according to claim 19, improving the chargeable/dischargeable quantity of the overall energy storage device by selecting the ratio of the compound capable of performing a doping/dedoping reaction in a doped state with respect to the overall compound capable of performing a doping/dedoping reaction and the classification of p-type/n-type/pn-type in response to the ratio between the chargeable/dischargeable quantities of the positive electrode and the negative electrode when mixing said compound capable of performing a doping/dedoping reaction into the electrolytic solution.
